(19) United States
(12) Patent Application Publication
(10) Pub. No.: US 2013/0223946 A1
(43) Pub. Date: Aug. 29, 2013

(54) SYSTEM FOR CORRECTING THERMAL DISPLACEMENT OF MACHINE TOOL

(71) Applicant: Hideaki Yamamoto, Minato-ku (JP)

(72) Inventor: Hideaki Yamamoto, Minato-ku (JP)

(73) Assignee: MITSUBISHI HEAVY INDUSTRIES, LTD., Tokyo (JP)

(21) Appl. No.: 13/823,005

(22) PCT Filed: Oct. 5, 2011
(86) PCT No.: PCT/JP2011/072918

§ 371 Date: May 16, 2013

(30) Foreign Application Priority Data
Oct. 21, 2010 (JP) 2010-236424

(51) Int. Cl. B23Q 15/18

(52) U.S. Cl. CPC B23Q 15/18
USPC 409/80

(57) ABSTRACT

The purpose of the present invention is to provide a system for correcting thermal displacement of a machine tool, said system being capable of evaluating the amount of thermal displacement with a column front face serving as a reference position, and being capable of performing thermal displacement correction with good precision even when the amount of thermal displacement of a table is not uniform. For this purpose, the system is provided with, for example: a position detector temperature sensor (41-6); table temperature sensors (41-1 to 41-5); and a displacement correction device. The displacement correction device comprises: a temperature data input section for inputting temperature data (a6); a thermal displacement amount calculation section for calculating the amount of thermal displacement of the position detector on the basis of the temperature data (a6); a temperature data input section for inputting temperature data (a1 to a5); a thermal displacement amount calculation section for calculating, on the basis of the temperature data (a1 to a5), the amount of thermal displacement of the table corresponding to a temperature distribution in the X axis direction; a thermal displacement amount calculation section for calculating the amount of thermal displacement of the table system with the column front face serving as the reference position, said calculation being performed on the basis of the amount of thermal displacement of the table and the amount of thermal displacement of the position detector; and an X axis correction amount output section for outputting an X axis correction amount on the basis of the amount of thermal displacement of the table system.

### TECHNICAL FIELD

The present invention relates to a thermal displacement correction system for a machine tool.

### BACKGROUND ART

Generally, machine tools and the like employ, for their control systems, a fully-closed-loop feedback control system as shown in FIG. 12 in which positional information on a mechanical end is detected by a position detector 1 and used as a position feedback. Here, mechanical displacement is caused by heat sources such as a spindle and a servomotor 2 given inside the machine and changes in ambient temperature. The mechanical displacement deteriorates static accuracies such as the accuracy of positioning on each movement axis and the accuracy of positioning in a three-dimensional space. Note that the mechanical displacement occurs not only by thermal displacement but also by deflection with the machine's own weight and the like.

Further, in a case of employing a semi-closed loop feedback control system as shown in FIG. 13 for a control system of a machine tool or the like, the static accuracies tend to become even worse because the rotational position of the servomotor 2 detected by a pulse coder 3 is used as the position feedback. The mechanical displacement as described above occurs similarly in controlling robots and the like.

Deterioration in static accuracy due to mechanical displacement as described above, in particular, deterioration in static accuracy due to mechanical displacement resulting from heat or the like, is a major cause of increase in machining error and is still a major problem today. Thermal displacement correction systems using temperature sensors as shown in FIGS. 14 and 15 have heretofore been proposed as measures against deterioration in static accuracy due to mechanical displacement resulting from heat.

FIG. 14 is a thermal displacement correction system (thermal displacement correction function) for a vertical machining center, detailed description of which will be omitted. In this thermal displacement correction system, temperature sensors 11 are buried in given parts (a column 12, a saddle 13, a head 14, a table 16, a workpiece W, and a bed 18) of the machine. Based on pieces of temperature data measured with these temperature sensors 11, the amount of thermal displacement of the machine is predicted using a simple calculation equation, and a mechanical coordinate or the like is then shifted by that displacement amount. As a result, the mechanical displacement amount is compensated. Note that 15 in FIG. 13 denotes a spindle.

FIG. 15 is a thermal displacement correction system (thermal displacement correction function) for a double-column-type machining center. In this thermal displacement correction system, temperature sensors 21 are buried in given parts (a column 22, a cross rail 23, a saddle 24, a spindle 27, a table 26, a workpiece W, and a bed 28) of the machine. Based on pieces of temperature data measured with these temperature sensors 21, the amount of thermal displacement of the machine is predicted using a simple calculation equation, and a mechanical coordinate or the like is then shifted by that displacement amount. As a result, the mechanical displacement amount is compensated. Note that 25 in FIG. 9 denotes a ram.

Here, Patent Documents 1 to 5 listed below are prior art documents related to these systems.

Meanwhile, thermal displacement of a machine tool occurs not only in mechanical structures with heat sources such as the spindle and the column but also in the table. Hence, as a measure against the thermal displacement of the table, Patent Document 6 listed below proposes a thermal displacement correction method for a machine tool taking thermal displacement of its table into consideration.

### PRIOR ART DOCUMENTS

### Patent Documents

Patent Document 1: Japanese Patent Application Publication No. Hei 10-6183
Patent Document 2: Japanese Patent Application Publication No. 2006-281420
Patent Document 3: Japanese Patent Application Publication No. 2006-15461
Patent Document 4: Japanese Patent Application Publication No. 2007-15094
Patent Document 5: Japanese Patent Application Publication No. 2008-183653
Patent Document 6: Japanese Patent No. 4359573

### SUMMARY OF THE INVENTION

### Problems to be Solved by the Invention

However, the thermal displacement correction method for a machine tool proposed by Patent Document 6 listed above has the following problems.

(1) In the method of Patent Document 6, the temperature of the table is assumed to be uniform. However, the temperature is not always uniform over the entire table, especially in a case of a large-sized machine tool and therefore of a large-sized table. For this reason, the amount of thermal displacement varies from one portion of the table to another (the table has no particular heat source and is therefore thermally displaced as a result of being influenced by changes in the ambient temperature, coolant used for machining, etc.).
(2) In the method of Patent Document 6, the fixed position of a workpiece on the table is defined. Defining the fixed position of a workpiece is possible for small workpieces but is difficult for workpieces of large-sized machine tools. That is, a method in which a workpiece to be deformed is defined as a reference position is not realistic.
(3) In the method of Patent Document 6, the position of the center of the tool serves as a reference position of thermal displacement. In reality, however, thermal displacement exists in the following two lines with the front surface of the column serving as the reference position. On the other hand, the method of Patent Document 6 discusses thermal displacement of one line only, and the reference position is not the front surface of the column.

Thermal displacement of table system: column→position detector→table (→workpiece)

Thermal displacement of spindle system: column→cross rail→saddle→spindle→(attachment→) tool

Thus, in view of the above circumstances, an object of the present invention is to provide a thermal displacement correction system for a machine tool, the thermal displacement correction system capable of: evaluating the amount of thermal displacement with the front surface of a column serving as a reference position; performing accurate thermal displacement correction even under the presence of a temperature distribution in a table and thus variations in the amount of thermal displacement of the table; and further collective accurate displacement correction by taking into account not only displacement of a table system but also displacement of a spindle system.

### Means for Solving the Problems

A thermal displacement correction system for a machine tool of a first aspect of the invention for solving the problems is a thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:

a position-detector temperature sensor which is disposed in the position detector, detects a temperature of the position detector, and outputs temperature data;

a plurality of table temperature sensors which are disposed in given portions of the table along the X-axis direction, detect temperatures of the given portions of the table, and output pieces of temperature data, respectively; and

a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit, and
an X-axis-correction-amount output unit which finds an X-axis correction amount on the basis of the amount of the thermal displacement of the table system calculated by the table-system thermal-displacement-amount calculation unit and outputs the X-axis correction amount.

A thermal displacement correction system for a machine tool of a second aspect of the invention is a thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:

a position-detector temperature sensor which is disposed in the position detector, detects a temperature of the position detector, and outputs temperature data;

a plurality of table temperature sensors which are disposed in given portions of the table along the X-axis direction, detect temperatures of the given portions of the table, and output pieces of temperature data, respectively;

a support-member temperature sensor which is disposed in the support member for the spindle system, detects a temperature of the support member for the spindle system, and outputs temperature data; and

a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit, and
an X-axis-correction-amount output unit which finds an X-axis correction amount on the basis of the amount of the thermal displacement of the table system calculated by the table-system thermal-displacement-amount calculation unit and the amount of the thermal displacement of the spindle system calculated by the spindle-system thermal-displacement-amount calculation unit and outputs the X-axis correction amount.

A thermal displacement correction system for a machine tool of a third aspect of the invention is a thermal displacement correction system for a machine tool including: a spindle with a tool mounted thereto; a column; a support member fora spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:

a position-detector temperature sensor which is disposed in the position detector, detects a temperature of the position detector, and outputs temperature data;

a plurality of table temperature sensors which are disposed in given portions of the table along the X-axis direction, detect temperatures of the given portions of the table, and output pieces of temperature data, respectively;

a support-member temperature sensor which is disposed in the support member for the spindle system, detects a temperature of the support member for the spindle system, and outputs temperature data;

column temperature sensors which are disposed in a front surface side and a rear surface side of the column, detect temperatures of the front surface side and the rear surface side of the column, and respectively output pieces of temperature data; and

a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit,
a column temperature-data input unit which receives the pieces of temperature data from the column temperature sensors,
a column inclination-displacement-amount calculation unit which calculates an amount of inclination displacement of the column on the basis of the pieces of temperature data received by the column temperature-data input unit,
a spindle-system displacement-amount calculation unit which calculates an amount of displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit, and
an X-axis-correction-amount output unit which finds an X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount.

A thermal displacement correction system for a machine tool of a fourth aspect of the invention is characterized in that, in the thermal displacement correction system for a machine tool of the third aspect of the invention,

the spindle-system temperature-data input unit receives the pieces of temperature data from the support-member temperature sensor and the column temperature sensors, and

the spindle-system thermal-displacement-amount calculation unit calculates the amount of the thermal displacement of the spindle system with the front surface of the column serving as the reference position, on the basis of the pieces of temperature data from the support-member temperature sensor and the column temperature sensors received by the spindle-system temperature-data input unit.

A thermal displacement correction system for a machine tool of a fifth aspect of the invention is a thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:

a position-detector temperature sensor which is disposed in the position detector, detects a temperature of the position detector, and outputs temperature data;

a plurality of table temperature sensors which are disposed in given portions of the table along the X-axis direction, detect temperatures of the given portions of the table, and output pieces of temperature data, respectively;

a support-member temperature sensor which is disposed in the support member for the spindle system, detects a temperature of the support member for the spindle system, and outputs temperature data;

a level which is disposed on the column, detects an inclination angle of the column, and outputs inclination data; and

a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit,
a column inclination-data input unit which receives the inclination data from the level,
a column inclination-displacement-amount calculation unit which calculates an amount of inclination displacement of the column on the basis of the inclination data received by the column inclination-data input unit,
a spindle-system displacement-amount calculation unit which calculates an amount of displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit, and
an X-axis-correction-amount output unit which finds an X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount.

A thermal displacement correction system for a machine tool of a sixth aspect of the invention is characterized in that, in the thermal displacement correction system for a machine tool of the fifth aspect of the invention, thermal displacement correction system further comprises a column temperature sensor which is disposed in the column, detects a temperature of the column, and outputs temperature data, wherein

the spindle-system temperature-data input unit receives the pieces of temperature data from the support-member temperature sensor and the column temperature sensor, and

the spindle-system thermal-displacement-amount calculation unit calculates the amount of the thermal displacement of the spindle system with the front surface of the column serving as the reference position, on the basis of the pieces of temperature data from the support-member temperature sensor and the column temperature sensor received by the spindle-system temperature-data input unit.

### Effects of the Invention

The thermal displacement correction system for a machine tool of the first aspect of the invention is a thermal displacement correction system for a machine tool including: the spindle with the tool mounted thereto; the column; the support member (e.g. a cross rail, a saddle, a ram, a spindle bearing, etc.) for the spindle system, the support member provided between the spindle and the column; the table movable in the X-axis direction which is the front-rear direction of the column; and the position detector which detects the position of the table in the X-axis direction. The thermal displacement correction system is characterized in that it includes: the position-detector temperature sensor which is disposed in the position detector, detects the temperature of the position detector, and outputs the temperature data; the multiple table temperature sensors which are disposed in the given portions of the table along the X-axis direction, detect the temperatures of the given portions of the table, and output the pieces of temperature data, respectively; and the displacement correction device. The displacement correction device includes: the position-detector temperature-data input unit which receives the temperature data from the position-detector temperature sensor; the position-detector thermal-displacement-amount calculation unit which calculates the amount of the thermal displacement of the position detector on the basis of the temperature data received by the position-detector temperature-data input unit; the table temperature-data input unit which receives the pieces of temperature data from the table temperature sensors; the table thermal-displacement-amount calculation unit which calculates the amount of the thermal displacement of the table corresponding to the temperature distribution in the X-axis direction occurring in the table, on the basis of the pieces of temperature data received by the table temperature-data input unit; the table-system thermal-displacement-amount calculation unit which calculates the amount of the thermal displacement of the table system with the front surface of the column serving as the reference position, on the basis of the amount of the thermal displacement of the position detector calculated by the position-detector thermal-displacement-amount calculation unit and the amount of the thermal displacement of the table calculated by the table thermal-displacement-amount calculation unit; and the X-axis-correction-amount output unit which finds the X-axis correction amount on the basis of the amount of the thermal displacement of the table system calculated by the table-system thermal-displacement-amount calculation unit and outputs the X-axis correction amount. Accordingly, it is possible to evaluate the amount of the thermal displacement of the table system (column→position detector→table) with the front surface of the column serving as the reference position. Moreover, it is possible to perform accurate displacement correction even under the presence of a temperature distribution in the table and thus variations in the amount of the thermal displacement of the table.

The thermal displacement correction system for a machine tool of the second aspect of the invention is a thermal displacement correction system for a machine tool including: the spindle with the tool mounted thereto; the column; the support member (e.g. the cross rail, the saddle, the ram, the spindle bearing, etc.) for the spindle system, the support member provided between the spindle and the column; the table movable in the X-axis direction which is the front-rear direction of the column; and the position detector which detects the position of the table in the X-axis direction. The thermal displacement correction system is characterized in that it includes: the position-detector temperature sensor which is disposed in the position detector, detects the temperature of the position detector, and outputs the temperature data; the multiple table temperature sensors which are disposed in the given portions of the table along the X-axis direction, detect the temperatures of the given portions of the table, and output the pieces of temperature data, respectively; the support-member temperature sensor which is disposed in the support member for the spindle system, detects the temperature of the support member for the spindle system, and outputs the temperature data; and the displacement correction device. The displacement correction device includes: the position-detector temperature-data input unit which receives the temperature data from the position-detector temperature sensor; the position-detector thermal-displacement-amount calculation unit which calculates the amount of the thermal displacement of the position detector on the basis of the temperature data received by the position-detector temperature-data input unit; the table temperature-data input unit which receives the pieces of temperature data from the table temperature sensors; the table thermal-displacement-amount calculation unit which calculates the amount of the thermal displacement of the table corresponding to the temperature distribution in the X-axis direction occurring in the table, on the basis of the pieces of temperature data received by the table temperature-data input unit; the table-system thermal-displacement-amount calculation unit which calculates the amount of the thermal displacement of the table system with the front surface of the column serving as the reference position, on the basis of the amount of the thermal displacement of the position detector calculated by the position-detector thermal-displacement-amount calculation unit and the amount of the thermal displacement of the table calculated by the table thermal-displacement-amount calculation unit; the spindle-system temperature-data input unit which receives the temperature data from the support-member temperature sensor; the spindle-system thermal-displacement-amount calculation unit which calculates the amount of the thermal displacement of the spindle system with the front surface of the column serving as the reference position, on the basis of the temperature data received by the spindle-system temperature-data input unit; and the X-axis-correction-amount output unit which finds the X-axis correction amount on the basis of the amount of the thermal displacement of the table system calculated by the table-system thermal-displacement-amount calculation unit and the amount of the thermal displacement of the spindle system calculated by the spindle-system thermal-displacement-amount calculation unit and outputs the X-axis correction amount. Accordingly, it is possible to evaluate the amount of the thermal displacement of the table system (column→position detector→table) and of the spindle system (column→support member for spindle system→spindle) with the front surface of the column serving as the reference position. Moreover, it is possible to perform accurate displacement correction even under the presence of a temperature distribution in the table and thus variations in the amount of the thermal displacement of the table. Further, it is possible to design a thermal displacement model of the whole machine tool which collectively handles the amount of the thermal displacement of the table system and the amount of the thermal displacement of the spindle system. Hence, obtained is a more accurate displacement correction system.

The thermal displacement correction system for a machine tool of the third aspect of the invention is a thermal displacement correction system for a machine tool including: the spindle with the tool mounted thereto; the column; the support member (e.g. the cross rail, the saddle, the ram, the spindle bearing, etc.) for the spindle system, the support member provided between the spindle and the column; the table movable in the X-axis direction which is the front-rear direction of the column; and the position detector which detects the position of the table in the X-axis direction. The thermal displacement correction system is characterized in that it includes: the position-detector temperature sensor which is disposed in the position detector, detects the temperature of the position detector, and outputs the temperature data; the multiple table temperature sensors which are disposed in the given portions of the table along the X-axis direction, detect the temperatures of the given portions of the table, and output the pieces of temperature data, respectively; the support-member temperature sensor which is disposed in the support member for the spindle system, detects the temperature of the support member for the spindle system, and outputs the temperature data; the column temperature sensors which are disposed in the front surface side and the rear surface side of the column, detect the temperatures of the front surface side and the rear surface side of the column, and respectively output the pieces of temperature data; and the displacement correction device. The displacement correction device includes: the position-detector temperature-data input unit which receives the temperature data from the position-detector temperature sensor; the position-detector thermal-displacement-amount calculation unit which calculates the amount of the thermal displacement of the position detector on the basis of the temperature data received by the position-detector temperature-data input unit; the table temperature-data input unit which receives the pieces of temperature data from the table temperature sensors; the table thermal-displacement-amount calculation unit which calculates the amount of the thermal displacement of the table corresponding to the temperature distribution in the X-axis direction occurring in the table, on the basis of the pieces of temperature data received by the table temperature-data input unit; the table-system thermal-displacement-amount calculation unit which calculates the amount of the thermal displacement of the table system with the front surface of the column serving as the reference position, on the basis of the amount of the thermal displacement of the position detector calculated by the position-detector thermal-displacement-amount calculation unit and the amount of the thermal displacement of the table calculated by the table thermal-displacement-amount calculation unit; the spindle-system temperature-data input unit which receives the temperature data from the support-member temperature sensor; the spindle-system thermal-displacement-amount calculation unit which calculates the amount of the thermal displacement of the spindle system with the front surface of the column serving as the reference position, on the basis of the temperature data received by the spindle-system temperature-data input unit; the column temperature-data input unit which receives the pieces of temperature data from the column temperature sensors; the column inclination-displacement-amount calculation unit which calculates the amount of the inclination displacement of the column on the basis of the pieces of temperature data received by the column temperature-data input unit; the spindle-system displacement-amount calculation unit which calculates the amount of the displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit; and the X-axis-correction-amount output unit which finds the X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount. Accordingly, it is possible to evaluate the amount of the thermal displacement of the table system (column—position detector→table) and of the spindle system (column→support member for spindle system→spindle) in with the front surface of the column serving as the reference position. Moreover, it is possible to perform accurate displacement correction even under the presence of a temperature distribution in the table and thus variations in the amount of the thermal displacement of the table. Further, it is possible to design a thermal displacement model of the whole machine tool which collectively handles the amount of the thermal displacement of the table system and the amount of the thermal displacement of the spindle system. Hence, obtained is a more accurate displacement correction system. Furthermore, it is possible to perform even more accurate displacement correction because the amount of the inclination displacement of the column is taken into consideration in addition to the amounts of the thermal displacements of the table system and spindle system.

The thermal displacement correction system for a machine tool of the fourth aspect of the invention is the thermal displacement correction system for a machine tool of the third aspect of the invention and is characterized in that the spindle-system temperature-data input unit receives the pieces of temperature data from the support-member temperature sensor and the column temperature sensors, and the spindle-system thermal-displacement-amount calculation unit calculates the amount of the thermal displacement of the spindle system with the front surface of the column serving as the reference position, on the basis of the pieces of temperature data from the support-member temperature sensor and the column temperature sensors received by the spindle-system temperature-data input unit. Accordingly, by evaluating the amount of the thermal displacement of the spindle system taking the column's temperature data into consideration, it is possible to perform even more accurate displacement correction.

The thermal displacement correction system for a machine tool of the fifth aspect of the invention is a thermal displacement correction system for a machine tool including: the spindle with the tool mounted thereto; the column; the support member (e.g. the cross rail, the saddle, the ram, the spindle bearing, etc.) for the spindle system, the support member provided between the spindle and the column; the table movable in the X-axis direction which is the front-rear direction of the column; and the position detector which detects the position of the table in the X-axis direction. The thermal displacement correction system is characterized in that it includes: the position-detector temperature sensor which is disposed in the position detector, detects the temperature of the position detector, and outputs the temperature data; the multiple table temperature sensors which are disposed in the given portions of the table along the X-axis direction, detect the temperatures of the given portions of the table, and output the pieces of temperature data, respectively; the support-member temperature sensor which is disposed in the support member for the spindle system, detects the temperature of the support member for the spindle system, and outputs the temperature data; the level which is disposed on the column, detects the inclination angle of the column, and outputs the inclination data; and the displacement correction device. The displacement correction device includes: the position-detector temperature-data input unit which receives the temperature data from the position-detector temperature sensor; the position-detector thermal-displacement-amount calculation unit which calculates the amount of the thermal displacement of the position detector on the basis of the temperature data received by the position-detector temperature-data input unit; the table temperature-data input unit which receives the pieces of temperature data from the table temperature sensors; the table thermal-displacement-amount calculation unit which calculates the amount of the thermal displacement of the table corresponding to the temperature distribution in the X-axis direction occurring in the table, on the basis of the pieces of temperature data received by the table temperature-data input unit; the table-system thermal-displacement-amount calculation unit which calculates the amount of the thermal displacement of the table system with the front surface of the column serving as the reference position, on the basis of the amount of the thermal displacement of the position detector calculated by the position-detector thermal-displacement-amount calculation unit and the amount of the thermal displacement of the table calculated by the table thermal-displacement-amount calculation unit; the spindle-system temperature-data input unit which receives the temperature data from the support-member temperature sensor; the spindle-system thermal-displacement-amount calculation unit which calculates the amount of the thermal displacement of the spindle system with the front surface of the column serving as the reference position, on the basis of the temperature data received by the spindle-system temperature-data input unit; the column inclination-data input unit which receives the inclination data from the level; the column inclination-displacement-amount calculation unit which calculates the amount of the inclination displacement of the column on the basis of the inclination data received by the column inclination-data input unit; the spindle-system displacement-amount calculation unit which calculates the amount of the displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit; and the X-axis-correction-amount output unit which finds the X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount. Accordingly, it is possible to evaluate the amount of the thermal displacement of the table system (column→position detector→able) and of the spindle system (column→support member for spindle system→spindle) with the front surface of the column serving as the reference position. Moreover, it is possible to perform accurate displacement correction even under the presence of a temperature distribution in the table and thus variations in the amount of the thermal displacement of the table. Further, it is possible to design a thermal displacement model of the whole machine tool which collectively handles the amount of the thermal displacement of the table system and the amount of the thermal displacement of the spindle system. Hence, obtained is a more accurate displacement correction system. Furthermore, it is possible to perform even more accurate displacement correction because the amount of the inclination displacement of the column is taken into consideration in addition to the amounts of the thermal displacements of the table system and spindle system.

The thermal displacement correction system for a machine tool of the sixth aspect of the invention is the thermal displacement correction system for a machine tool of the fifth aspect of the invention and is characterized in that the thermal displacement correction system further includes the column temperature sensor which is disposed in the column, detects the temperature of the column, and outputs the temperature data. The spindle-system temperature-data input unit receives the pieces of temperature data from the support-member temperature sensor and the column temperature sensor. The spindle-system thermal-displacement-amount calculation unit calculates the amount of the thermal displacement of the spindle system with the front surface of the column serving as the reference position, on the basis of the pieces of temperature data from the support-member temperature sensor and the column temperature sensor received by the spindle-system temperature-data input unit. Accordingly, by evaluating the amount of the thermal displacement of the spindle system taking the column's temperature data into consideration, it is possible to perform even more accurate displacement correction.

### BRIEF DESCRIPTION OF THE DRAWINGS

FIG. 1 is a view related to a thermal displacement correction system for a machine tool according to Embodiment 1 of the present invention and is a side view of the machine tool showing the arrangement of temperature sensors.

FIG. 2 is a diagram related to the thermal displacement correction system for a machine tool according to Embodiment 1 of the present invention and is a block diagram showing the configuration of a displacement correction device side.

Part (a) of FIG. 3 is a diagram showing a temperature distribution of a table, and Part (b) of FIG. 3 is a diagram showing a distribution of the amount of thermal displacement of the table per unit length.

FIG. 4 is a view related to a thermal displacement correction system for a machine tool according to Embodiment 2 of the present invention and is a side view of the machine tool showing the arrangement of temperature sensors.

FIG. 5 is a diagram related to the thermal displacement correction system for a machine tool according to Embodiment 2 of the present invention and is a block diagram showing the configuration of a displacement correction device side.

FIG. 6 is a view related to a thermal displacement correction system for a machine tool according to Embodiment 3 of the present invention and is a side view of the machine tool showing the arrangement of temperature sensors.

FIG. 7 is a diagram related to the thermal displacement correction system for a machine tool according to Embodiment 3 of the present invention and is a block diagram showing the configuration of a displacement correction device side.

FIG. 8 is an explanatory diagram related to equations for calculating the amount of inclination displacement of a column due to the temperature difference between a front surface side and a rear surface side of the column.

FIG. 9 is an explanatory diagram related to equations for calculating the amount of the inclination displacement of the column due to the temperature difference between the front surface side and the rear surface side of the column.

FIG. 10 is a view related to a thermal displacement correction system for a machine tool according to Embodiment 4 of the present invention and is a side view of the machine tool showing the arrangement of temperature sensors and a level.

FIG. 11 is a diagram related to the thermal displacement correction system for a machine tool according to Embodiment 4 of the present invention and is a block diagram showing the configuration of a displacement correction device side.

FIG. 12 is a block diagram of a conventional fully-closed-loop feedback control device.

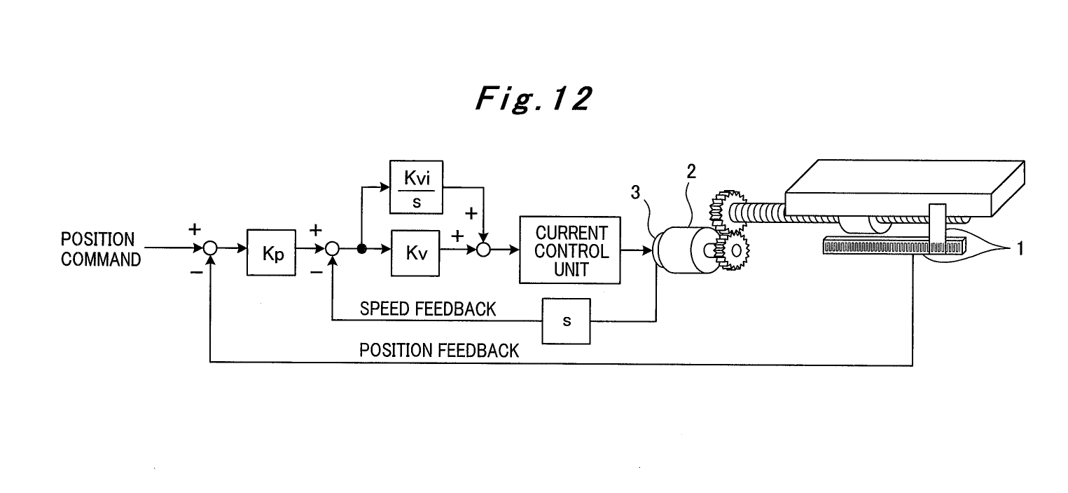

FIG. 13 is a block diagram of a conventional semi-closed-loop feedback control device.

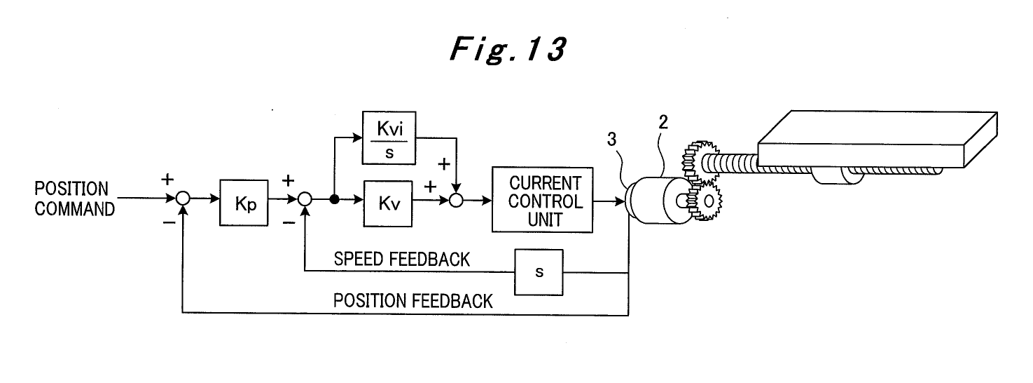

FIG. 14 is a block diagram of a conventional thermal displacement correction system of a vertical machining center using temperature sensors.

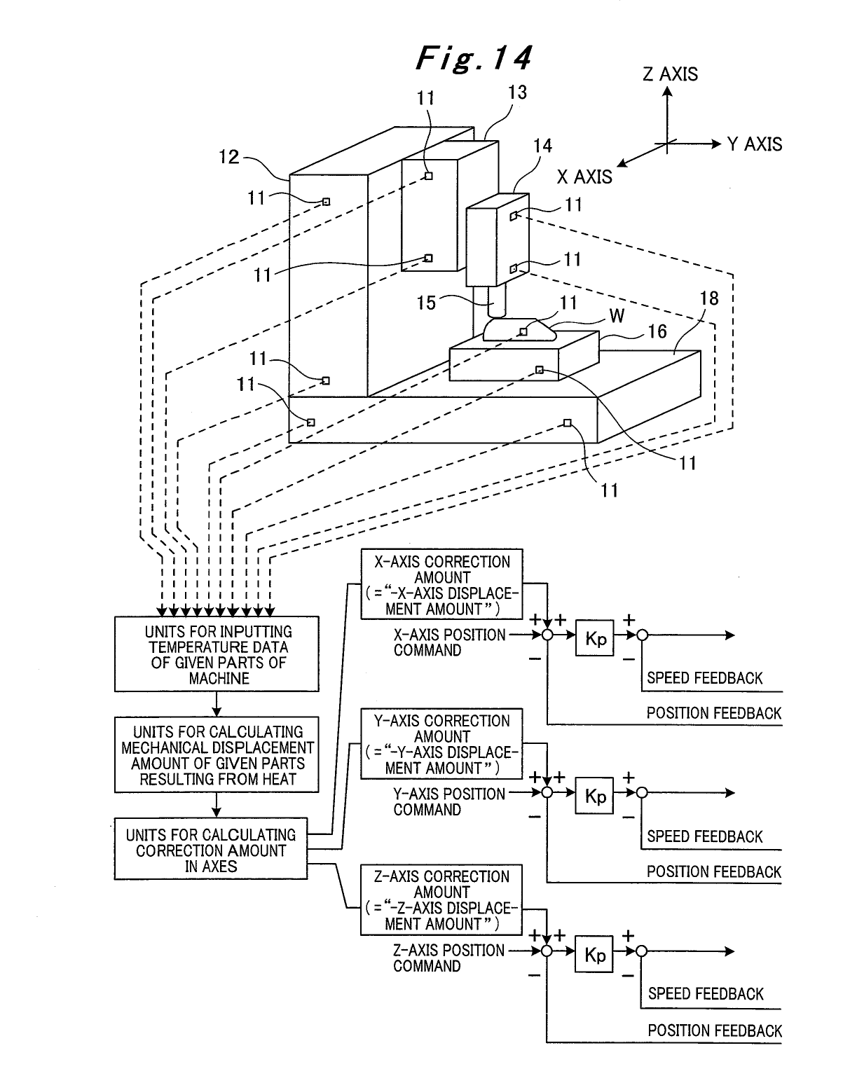

FIG. 15 is a block diagram of a conventional thermal displacement correction system of a double-column-type machining center using temperature sensors.

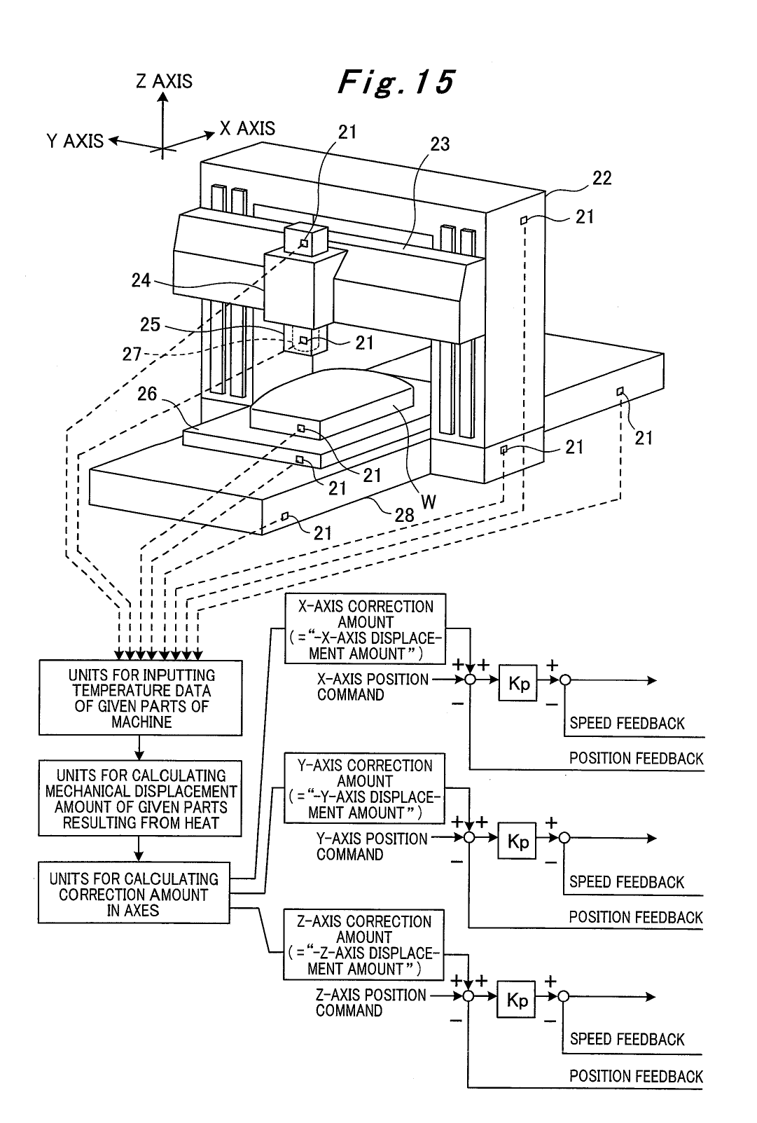

### MODES FOR CARRYING OUT THE INVENTION

Hereinbelow, embodiments of the present invention will be described in detail based on the drawings.

### Embodiment 1

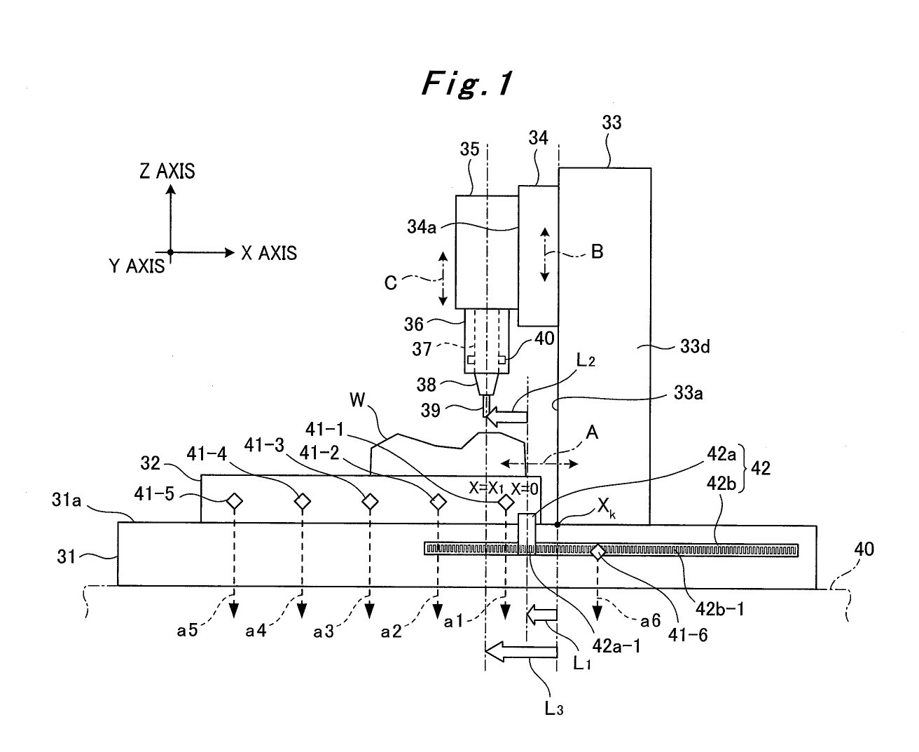

Based on FIGS. 1 to 3, a thermal displacement correction system for a machine tool according to Embodiment 1 of the present invention will be described.

As shown in FIG. 1, a machine tool includes: a bed 31; a table 32; a gate-shaped column 33; a cross rail 34; a saddle 35; a ram 36; a spindle 37 incorporated in the ram 36 in a rotatably supported state; a tool 39 mounted to the spindle 37 through an attachment 38; and a position detector 42.

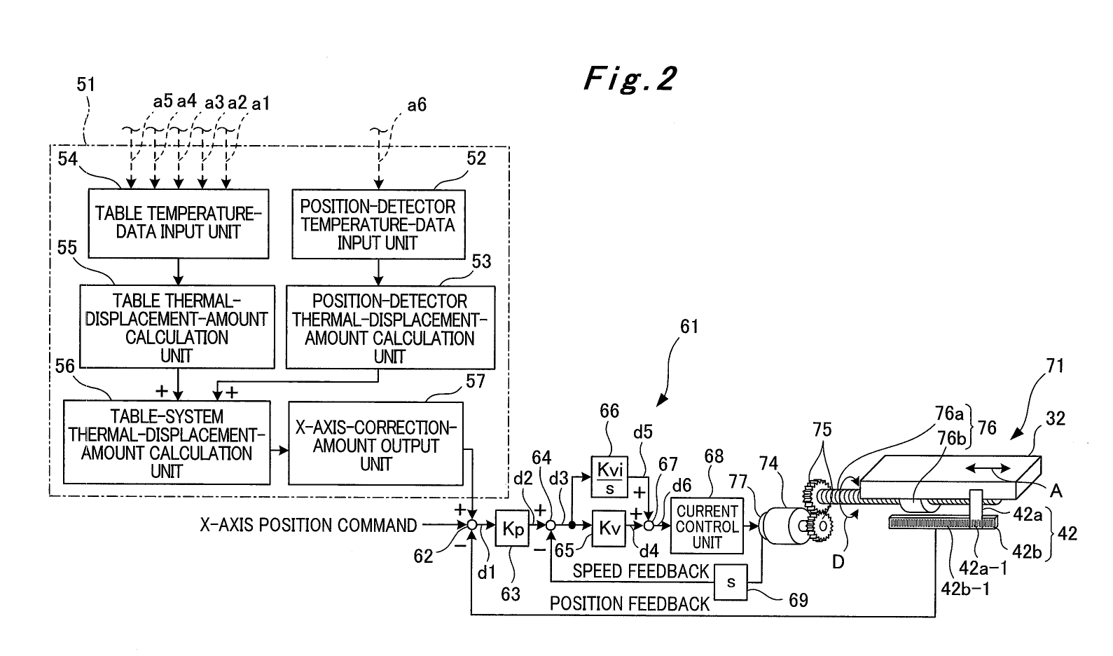

The bed 31 is disposed on a floor surface 40. The table 32 and the column 33 are disposed on the bed 31. A workpiece W is placed on the table 32. The table 32 is movable straightly along guiderails (not shown) laid on an upper surface 31a of the bed 31 in a horizontal X-axis direction (the front-rear direction of the column 33) as illustrated with arrow A by means of a feed mechanism (not shown in FIG. 1; see FIG. 2). The cross rail 34 is disposed on a front surface 33a of the column 33, and is movable straightly along guiderails (not shown) laid on the column front surface 33a in a vertical Z-axis direction as illustrated with arrow B by means of a feed mechanism (not shown). The saddle 35 is disposed on a front surface 34a of the cross rail 34, and is movable straightly along the cross rail 34 in a horizontal Y-axis direction (a direction perpendicular to the sheet of FIG. 1) by means of a feed mechanism (not shown). The ram 36 is provided in the saddle 35, and is movable in the Z-axis direction as illustrated with arrow C by means of a feed mechanism (not shown). The spindle 37 is provided in the ram 36 and rotatably supported by a spindle bearing 40. Note that the X, Y, and Z axes are perpendicular to each other.

Moreover, multiple (five in the illustrated example) table temperature sensors 41-1, 41-2, 41-3, 41-4, and 41-5 are disposed in the table 32. These table temperature sensors 41-1 to 41-5 are arranged in given portions of the table 32 at equal intervals in the X-axis direction. Thus, the table temperature sensors 41-1 to 41-5 detect the temperatures of the given portions of the table 32 and output pieces of detected temperature data a1, a2, a3, a4, and a5 to the machine tool's displacement correction device 51 (see FIG. 2; details will be described later), respectively.

The position detector 42 is a general inductosyn linear scale which is formed of a slider 42a and a scale 42b. The scale 42b includes a zigzag coil 42b-1 and is attached to the bed 31 along the X-axis direction (the longitudinal direction is along the X-axis direction). The slider 42a includes a zigzag coil 42a-1 and is attached to the table 32 while facing the scale 42b. When current is caused to flow in the coil 42a-1 of the slider 42a, voltage is generated across the coil 42b-1 of the scale 42b due to the electromagnetic induction. Thus, as the slide 42a moves in the X-axis direction together with the table 32, the relative position between the slider 42a and the scale 42b changes, and thus the voltage changes. This voltage change allows detection of the position of the slider 42a in the X-axis direction, i.e. the position of the table 32 (workpiece W) in the X-axis direction. The position detector 42 detects the position of the table 32 (workpiece W) as described above and outputs detected position data to the machine tool's feedback control device 61 (see FIG. 2; details will be described later) (position feedback).

Moreover, a position-detector temperature sensor 41-6 is disposed in the scale 42b of the position detector 42. The position-detector temperature sensor 41-6 detects the temperature of the position detector 42 (scale 42b) and outputs detected temperature data a6 to the machine tool's displacement correction device 51.

Note that although the position detector 42 is described above as an inductosyn linear scale, the linear scale is not limited to inductosyn types. It is possible to use a linear scale of some other type as the position detector 42.

Next, the machine tool's displacement correction device 51, feedback control device 61, and table feed mechanism 71 will be described based on FIGS. 1, 2, and 3.

The displacement correction device 51 is configured by using a personal computer or the like and includes a position-detector temperature-data input unit 52, a position-detector thermal-displacement-amount calculation unit 53, a table temperature-data input unit 54, a table thermal-displacement-amount calculation unit 55, a table-system thermal-displacement-amount calculation unit 56, and an X-axis-correction-amount output unit 57 as shown in FIG. 2.

The position-detector temperature-data input unit 52 receives the temperature data a6 on the position detector 42 (scale 42b) outputted from the position-detector temperature sensor 41-6.

The position-detector thermal-displacement-amount calculation unit 53 calculates an amount ΔL₁ of thermal displacement of the position detector 42 (scale 42b) in the X-axis direction on the basis of the temperature data a6 on the position detector 42 (scale 42b) received by the position-detector temperature-data input unit 52.

Equation (1) given below is an example equation for calculating the thermal displacement amount of the position detector 42 (scale 42b) and of other parts of the machine tool (such as the ram 36, the spindle bearing 40, the saddle 35, the cross rail 34, and the column 33). Note that the other embodiments will provide description for the thermal displacement amount of parts of the machine tool other than the position detector 42.

$$\begin{matrix}[ Formula 1 ] & \\ \begin{matrix}Δ L = {k}_{1} \times β \times ( T - {T}_{0} ) \times L \times {10}^{6} \\ = {k}_{1} \times β \times Δ T \times L \times {10}^{6}\end{matrix} & ( 1 )\end{matrix}$$

where ΔL is the thermal displacement amount [μm] of a given part of the machine tool such as the position detector 42 (scale 42b); k₁, a correction coefficient; β, the linear expansion coefficient [1/(° C.×m)] of the given part of the machine tool such as the position detector 42 (scale 42b); T₀, a reference temperature [° C.]; T, the temperature data [° C.] on the given part of the machine tool such as the position detector 42 (scale 42b); ΔT, the temperature difference between the temperature data T and the reference temperature T₀ (T−T₀); and L, the object effective length [m] of the given part of the machine tool such as the position detector 42 (scale 42b) (the length of a portion of the given part of the machine tool related to the thermal displacement amount in the X-axis direction).

Then, the thermal displacement amount ΔL₁ of the position detector 42 (scale 42b) in the X-axis direction can be obtained by substituting the linear expansion coefficient β of the position detector 42 (scale 42b), the temperature difference ΔT between the reference temperature T₀ and the temperature data T on the position detector 42 (scale 42b) (the temperature data a6 of the position-detector temperature sensor 41-6), and the object effective length L of the position detector 42 (scale 42a) into Equation (1) to calculate ΔL. Note that the object effective length L of the position detector 42 (scale 42a) is a length L₁ shown in FIG. 1 from a reference position X_{K} (a reference position in the X-axis direction) being the column front surface 33a, to the position of the slider 42a (the position of the center of the slider 42a in the X-axis direction in the illustrated example). Thus, the object effective length L varies as the slider 42a moves. Moreover, the thermal displacement amount ΔL₁ of the position detector 42 (scale 42b) is the amount of thermal displacement occurring within a range of the length L₁ from the reference position X_{K} at the column front surface 33a to the position of the slider 42a, i.e. the amount of an error resulting from the thermal displacement of the position detector 42 (scale 42b) within the range of the length L₁.

The table temperature-data input unit 54 receives the pieces of temperature data a1 to a5 on the table 32 respectively outputted from the table temperature sensors 41-1 to 41-5.

The table thermal-displacement-amount calculation unit 55 calculates an amount ΔL₂ of thermal displacement of the table 32 corresponding to a temperature distribution in the X-axis direction occurring in the table 32, on the basis of the pieces of temperature data a1 to a5 on the table 32 received by the table temperature-data input unit 54.

Equations (2) and (3) given below are example calculation equations for calculating the thermal displacement amount ΔL₂ of the table 32 corresponding to the temperature distribution in the X-axis direction occurring in the table 32.

[Formula 2]

δ=k₂×β×(T−T₀)×10⁶ (2)

ΔL=∫_{X=0}^{X=X}^{ᵢ}δ(X)dx (3)

where δ is the thermal displacement amount [μm/m] of the table 32 per unit length; k₂, a correction coefficient; β, the linear expansion coefficient [1/(° C.×m)] of the table 32; T₀, a reference temperature [° C.]; T, the temperature data [° C.] on the table 32; ΔL, the thermal displacement amount [μm] of the table 32 corresponding to the temperature distribution in the X-axis direction occurring in the table 32; and X, Xᵢ, the position of the table 32 in the X-axis direction.

In Part (a) of FIG. 3, the horizontal axis represents the position [m] of the table 32 in the X-axis direction, while the vertical axis represents the temperature T [° C.] of the table 32. In Part (b) of FIG. 3, the horizontal axis represents the position [m] of the table 32 in the X-axis direction, while the vertical axis represents the thermal displacement amount δ [μm/m] of the table 32 per unit length. For example, if the table 32 has a temperature distribution in the X-axis direction as shown in Part (a) of FIG. 3, the thermal displacement amount δ of the table 32 per unit length would show a distribution in the X-axis direction as shown in Part (b) of FIG. 3. Then, from this distribution of the thermal displacement amount 5 of the table 32 per unit length, it is possible to calculate the thermal displacement amount ΔL₂ of the table 32 corresponding to the temperature distribution in the X-axis direction. Meanwhile, as shown in FIG. 1, X=0 is a position on the table at which the slider 42a is disposed (the position of the center of the slider 42a in the X-axis direction in the illustrated example).

Specifically, the pieces of temperature data a1 to a5 of the table temperature sensors 41-1 to 41-5 are sequentially substituted into Equation (2) as the temperature data T to obtain the table thermal displacement amounts δ per unit length corresponding to the pieces of temperature data T (a1 to a5) along the X-axis direction. For example, the temperature data a1 can be used to find the δ between X=0 and the position of the table temperature sensor 41-1 in the X-axis direction. The temperature data a2 can be used to find the δ between the position of the table temperature sensor 41-1 (excluding this position) and the position of the table temperature sensor 41-2 in the X-axis direction. The temperature data a3 can be used to find the δ between the position of the table temperature sensor 41-2 (excluding this position) and the position of the table temperature sensor 41-3 in the X-axis direction. The temperature data a4 can be used to find the δ between the position of the table temperature sensor 41-3 (excluding this position) and the position of the table temperature sensor 41-4 in the X-axis direction. The temperature data a5 can be used to find the δ between the position of the table temperature sensor 41-4 (excluding this position) and the position of the table temperature sensor 41-5 (or the end of the table 32) in the X-axis direction.

From these values of δ, it is possible to obtain an equation δ(X) that represents the distribution of the table thermal displacement amounts δ per unit length in the X-axis direction as exemplified in Part (b) of FIG. 3. Moreover, with this δ(X), integration is performed with respect to the positions X in the X-axis direction (0 to Xᵢ) as shown in Equation (3). As a result, calculated is the table thermal displacement amount ΔL (ΔL₂) corresponding to the temperature distribution in the X-axis direction occurring in the table 32. For example, at the position X=X₁ shown in FIG. 1, the table thermal displacement amount ΔL₂ is a thermal displacement amount within a range of the length L₂ from the position X=0, which is the position of the slider 42a, to the position X=X₁ (i.e. the amount of an error resulting from the thermal displacement of the table 32).

Next, as shown in FIG. 2, the table-system thermal-displacement-amount calculation unit 56 calculates the amount of thermal displacement of a table system (the amount of thermal displacement in the X-axis direction) by summing the thermal displacement amount ΔL₁ of the position detector 42 calculated by the position-detector thermal-displacement-amount calculation unit 53 and the table thermal displacement amount ΔL₂ calculated by the table thermal-displacement-amount calculation unit 55. For example, at the position X=X₁ shown in FIG. 1, the thermal displacement amount of the table system is a thermal displacement amount included within a range of a length L₃ from the reference position X_{K} at the column front surface 33a to the position X=X₁ (i.e. the amount of an X-axis error resulting from the thermal displacements of the position detector 42 (scale 42b) and table 32). The table-system thermal-displacement-amount calculation unit 56 outputs the calculated thermal displacement amount of the table system to the X-axis-correction-amount output unit 57 as an X-axis displacement amount of the table system.

Based on the X-axis displacement amount of the table system (the thermal displacement amount of the table system) received from the table-system thermal-displacement-amount calculation unit 56, the X-axis-correction-amount output unit 57 finds an X-axis correction amount (=“−X-axis displacement amount”) for the table system and outputs this X-axis correction amount (=“−X-axis displacement amount”) to the feedback control device 61.

As shown in FIG. 2, the table feed mechanism 71 is formed of a servomotor 74, reduction gears 75, a ball screw 76 (a screw part 78a and a nut part 76b), a pulse coder 77, and so on. The servomotor 74 is connected to the screw part 76a of the ball screw 76 through the reduction gears 75. The screw part 76a and the nut part 76b of the ball screw 76 are screwed with each other. The nut part 76b is attached to the table 32. Moreover, the slider 42a of the position detector 42 is attached to the table 32 as mentioned earlier. The pulse coder 77 is attached to the servomotor 74.

Thus, the table 32 moves together with the nut part 76b in the X-axis direction as illustrated with arrow A when the rotational force of the servomotor 74 is transmitted through the reduction gears 75 to the screw part 76a of the ball screw 76 to rotate the screw part 76a as illustrated with arrow D. Here, the position detector 42 detects the position of the table 32 (workpiece W) moved in the X-axis direction and sends detected position data to the feedback control device 61 (position feedback). Moreover, the pulse coder 77 detects the rotational angle of the servomotor 74 and sends detected rotational angle data to the feedback control device 61.

The feedback control device 61 is formed of a deviation computation unit 62, a multiplication unit 63, a deviation computation unit 64, a proportional computation unit 65, an integral computation unit 66, an adding unit 67, a current control unit 68, a derivative computation unit 69, and so on.

The deviation computation unit 62 adds the X-axis correction amount (=“−X-axis displacement amount”) sent from the displacement correction device 51 (X-axis-correction-amount output unit 57) to an X-axis position command sent from a numerical control device (not shown) to correct the X-axis position command. The deviation computation unit 62 computes the difference between this corrected X-axis position command and the position of the table 32 (workpiece W) which is the position feedback information from the position detector 42 to find a position deviation d1.

The multiplication unit 63 multiplies the position deviation d1 by a position loop gain Kp to find a speed command d2. The derivative computation unit 69 computes the derivative of the rotational angle of the servomotor 74 detected by the pulse coder 77 with respect to time to find the rotational speed of the servomotor 74. The deviation computation unit 64 computes the difference between the speed command d2 and the rotational speed of the servomotor 74 found by the derivative computation unit 69 to find a speed deviation d3. The proportional computation unit 65 multiplies the speed deviation d3 by a speed loop proportional gain Kv to find a proportional value d4. The integral computation unit 66 multiplies the speed deviation d3 by a speed loop integral gain Kvi and integrates the product to find an integral value d5. The adding unit 67 adds the proportional value d4 and the integral value d5 to find a torque command d6. The current control unit 68 controls supply of current to the servomotor 74 in such a way that the torque of the servomotor 74 follows the torque command d6.

Thus, this feedback control device 61 performs control such that the rotational speed of the servomotor 74 follows the speed command d2 and that the position of the table 52 moved in the X-axis direction follows the corrected X-axis position command.

As described above, the thermal displacement correction system for a machine tool in Embodiment 1 is a thermal displacement correction system for a machine tool including: the spindle 37 with the tool 39 mounted thereto; the column 33; the cross rail 34, the saddle 35, the ram 36, and the spindle bearing 40 provided between the spindle 37 and the column 33 as a support member for a spindle system; the table 32 movable in the X-axis direction which is the front-rear direction of the column 33; and the position detector 42 which detects the position of the table 32 in the X-axis direction. This thermal displacement correction system is characterized in that it includes: the position-detector temperature sensor 41-6 which is disposed in the position detector 42, detects the temperature of the position detector 42, and outputs the temperature data a6; the multiple table temperature sensors 41-1 to 41-5 which are disposed in the given portions of the table 32 along the X-axis direction, detect the temperatures of the given portions of the table 32, and output the pieces of temperature data a1 to a5, respectively; and the displacement correction device 51. The displacement correction device 51 includes: the position-detector temperature-data input unit 52 which receives the temperature data a6 from the position-detector temperature sensor 41-6; the position-detector thermal-displacement-amount calculation unit 53 which calculates the amount of the thermal displacement of the position detector 42 on the basis of the temperature data a6 received by the position-detector temperature-data input unit 52; the table temperature-data input unit 54 which receives the pieces of temperature data a1 to a5 from the table temperature sensors 41-1 to 41-5; the table thermal-displacement-amount calculation unit 55 which calculates the amount of the thermal displacement of the table 32 corresponding to the temperature distribution in the X-axis direction occurring in the table 32, on the basis of the pieces of temperature data a1 to a5 received by the table temperature-data input unit 54; the table-system thermal-displacement-amount calculation unit 56 which calculates the amount of the thermal displacement of the table system with the column front surface 33a serving as the reference position X_{K}, on the basis of the amount of the thermal displacement of the position detector 42 calculated by the position-detector thermal-displacement-amount calculation unit 53 and the amount of the thermal displacement of the table calculated by the table thermal-displacement-amount calculation unit 55; and the X-axis-correction-amount output unit 57 which finds the X-axis correction amount on the basis of the amount of the thermal displacement of the table system calculated by the table-system thermal-displacement-amount calculation unit 56 and outputs the X-axis correction amount. Accordingly, it is possible to evaluate the amount of the thermal displacement of the table system (column 33→osition detector 42→table 32) with the column front surface 33a serving as the reference position X_{K}. Moreover, it is possible to perform accurate displacement correction even under the presence of a temperature distribution in the table 32 and thus variations in the amount of the thermal displacement of the table 32.

### Embodiment 2

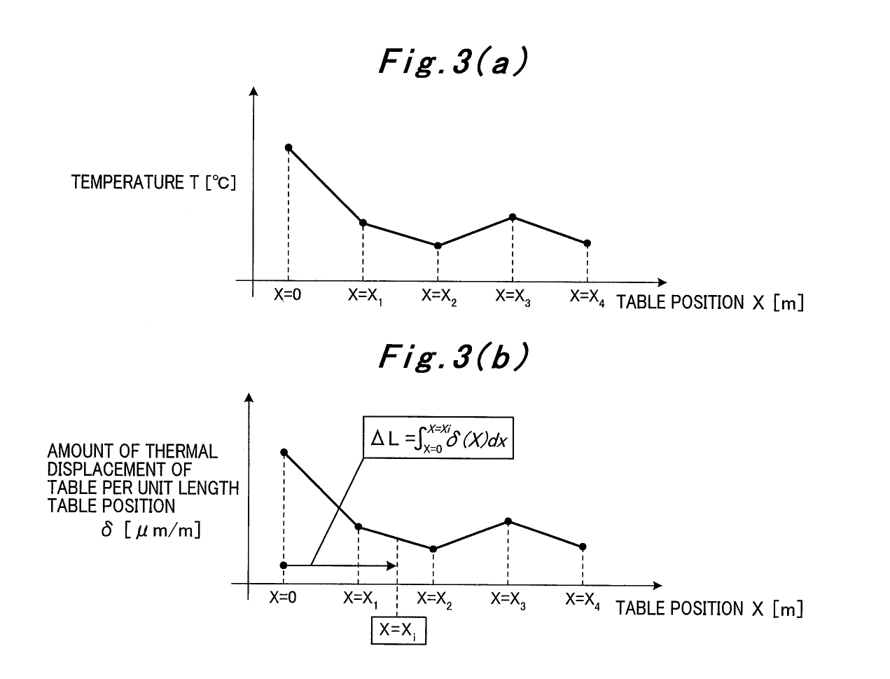

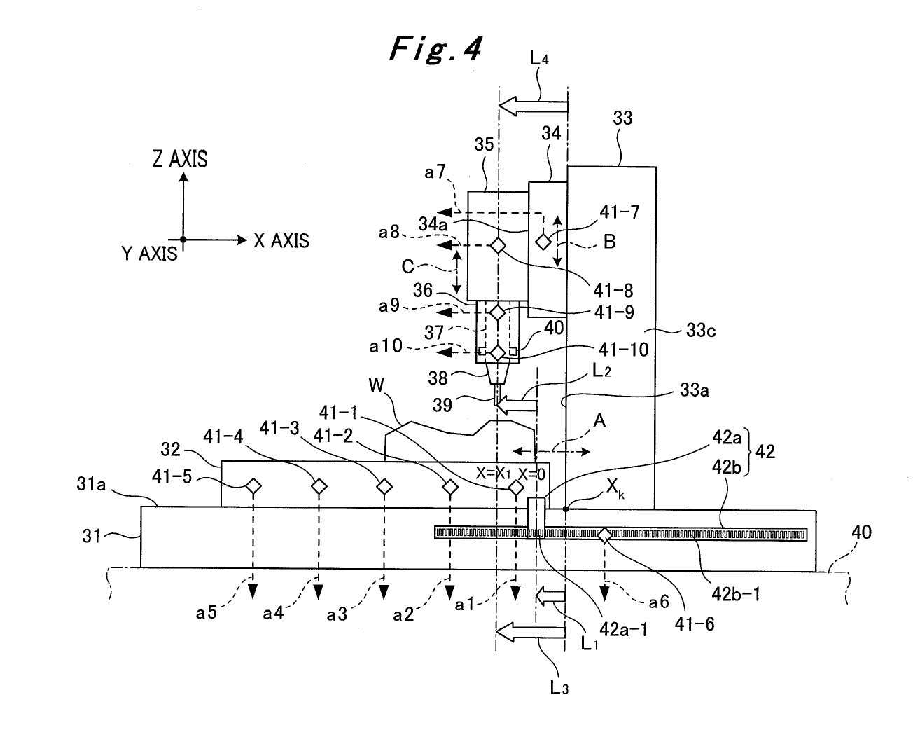

Based on FIGS. 4 and 5, a thermal displacement correction system for a machine tool according to Embodiment 2 of the present invention will be described. Note that in the thermal displacement correction system shown in FIGS. 4 and 5, the same portions as those of the thermal displacement correction system of Embodiment 1 described above will be denoted by the same reference numerals, and overlapping descriptions thereof will be omitted.

As shown in FIG. 4, in Embodiment 2, multiple temperature sensors 41-7, 41-8, 41-9, and 41-10 are further disposed in the machine tool, in addition to the same temperature sensors 41-1 to 41-6 as those described above.

The cross-rail temperature sensor 41-7 is disposed in the cross rail 34, detects the temperature of the cross rail 34, and outputs detected temperature data a7 to the machine tool's displacement correction device 81 (see FIG. 5; details will be described later). The saddle temperature sensor 41-8 is disposed in the saddle 35, detects the temperature of the saddle 35, and outputs detected temperature data a8 to the displacement correction device 81. The ram temperature sensor 41-9 is disposed in the ram 36, detects the temperature of the ram 36, and outputs detected temperature data a9 to the displacement correction device 81. The spindle-bearing temperature sensor 41-10 is disposed in the spindle bearing 40, detects the temperature of the spindle bearing 40, and outputs detected temperature data a10 to the displacement correction device 81.

As shown in FIG. 5, the displacement correction device 81 is configured by using a personal computer or the like and includes a spindle-system temperature-data input unit 82, a spindle-system thermal-displacement-amount calculation unit 83, and an X-axis-correction-amount output unit 84, in addition to the same position-detector temperature-data input unit 52, position-detector thermal-displacement-amount calculation unit 53, table temperature-data input unit 54, table thermal-displacement-amount calculation unit 55, and table-system thermal-displacement-amount calculation unit 56 as those described above.

The spindle-system temperature-data input unit 82 receives the temperature data a7 on the cross rail 34 outputted from the cross-rail temperature sensor 41-7, the temperature data a8 on the saddle 35 outputted from the saddle temperature sensor 41-8, the temperature data a9 on the ram 36 outputted from the ram temperature sensor 41-9, and the temperature data a10 on the spindle bearing 40 outputted from the spindle-bearing temperature sensor 41-10.

The spindle-system thermal-displacement-amount calculation unit 83 calculates the amount of thermal displacement of the spindle system in the X-axis direction on the basis of the pieces of temperature data a7 to a10 on the given parts of the spindle system received by the spindle-system temperature-data input unit 82.

Specifically, the spindle-system thermal-displacement-amount calculation unit 83 calculates the amount of thermal displacement of the cross rail 34 in the X-axis direction by substituting, into Equation (1) mentioned above, the linear expansion coefficient β of the cross rail 34, the temperature difference ΔT between the reference temperature T₀ and the temperature data T on the cross rail 34 (the temperature data a7 of the cross-rail temperature sensor 41-7), and the object effective length L of the cross rail 34. Moreover, the spindle-system thermal-displacement-amount calculation unit 83 calculates the amount of thermal displacement of the saddle 35 in the X-axis direction by substituting, into Equation (1) mentioned above, the linear expansion coefficient β of the saddle 35, the temperature difference ΔT between the reference temperature T₀ and the temperature data T on the saddle 35 (the temperature data a8 of the saddle temperature sensor 41-8), and the object effective length L of the saddle 35. Moreover, the spindle-system thermal-displacement-amount calculation unit 83 calculates the amount of thermal displacement of the ram 36 in the X-axis direction by substituting, into Equation (1) mentioned above, the linear expansion coefficient β of the ram 36, the temperature difference ΔT between the reference temperature T₀ and the temperature data T on the ram 36 (the temperature data a9 of the ram temperature sensor 41-9), and the object effective length L of the ram 36. Moreover, the spindle-system thermal-displacement-amount calculation unit 83 calculates the amount of thermal displacement of the spindle bearing 40 in the X-axis direction by substituting, into Equation (1) mentioned above, the linear expansion coefficient β of the spindle bearing 40, the temperature difference ΔT between the reference temperature T₀ and the temperature data T on the spindle bearing 40 (the temperature data a10 of the spindle-bearing temperature sensor 41-10), and the object effective length L of the spindle bearing 40.

Furthermore, the spindle-system thermal-displacement-amount calculation unit 83 uses the thermal displacement amount of the cross rail 34, the thermal displacement amount of the saddle 35, the thermal displacement amount of the ram 36, and the thermal displacement amount of the spindle bearing 40 thus calculated (e.g. sums them) to calculate the thermal displacement amount of the spindle system in the X-axis direction. For example, at the position X=X₁ shown in FIG. 4, the thermal displacement amount of the spindle system is a thermal displacement amount included within a range of a length L₄ from the reference position X_{K} being the column front surface 33a to the position X=X₁ (i.e. the amount of an X-axis error resulting from the thermal displacements of the cross rail 34, saddle 35, ram 36, and spindle bearing 40). The spindle-system thermal-displacement-amount calculation unit 83 outputs this calculated thermal displacement amount of the spindle system to the X-axis-correction-amount output unit 84 as an X-axis correction amount of the spindle system.

The X-axis-correction-amount output unit 84 uses the X-axis displacement amount of the table system (the thermal displacement amount of the table system) inputted from the table-system thermal-displacement-amount calculation unit 56 and the X-axis displacement amount of the spindle system (the thermal displacement amount of the spindle system) inputted from the spindle-system thermal-displacement-amount calculation unit 83 (e.g. subtracts one from the other) to find an X-axis correction amount (=“−X-axis displacement amount”) of the table system and of the spindle system and outputs this X-axis correction amount (=“−X-axis displacement amount”) to the feedback control device 61.

The deviation computation unit 62 of the feedback control device 61 adds the X-axis correction amount (=“−X-axis displacement amount”) sent from the displacement correction device 81 (X-axis-correction-amount output unit 84) to an X-axis position command sent from the numerical control device (not shown) to correct the X-axis position command. The deviation computation unit 62 computes the difference between this corrected X-axis position command and the position of the table 32 (workpiece W) which is the position feedback information from the position detector 42 to find the position deviation d1.

The other parts of the configuration of the thermal displacement correction system of Embodiment 2 are the same as those of the thermal displacement correction system of Embodiment 1 described above.

As described above, the thermal displacement correction system for a machine tool in Embodiment 2 is a thermal displacement correction system for a machine tool including: the spindle 37 with the tool 39 mounted thereto; the column 33; the cross rail 34, the saddle 35, the ram 36, and the spindle bearing 40 provided between the spindle 37 and the column 33 as the support member for the spindle system; the table 32 movable in the X-axis direction which is the front-rear direction of the column 33; and the position detector 42 which detects the position of the table 32 in the X-axis direction. This thermal displacement correction system is characterized in that it includes: the position-detector temperature sensor 41-6 which is disposed in the position detector 42, detects the temperature of the position detector 42, and outputs the temperature data a6; the multiple table temperature sensors 41-1 to 41-5 which are disposed in the given portions of the table 32 along the X-axis direction, detect the temperatures of the given portions of the table 32, and output the pieces of temperature data a1 to a5, respectively; the cross-rail temperature sensor 41-7, the saddle temperature sensor 41-8, the ram temperature sensor 41-9, and the spindle-bearing temperature sensor 41-10 as support-member temperature sensors which are disposed in the cross-rail 34, the saddle 35, the ram 36, and the spindle bearing 40 as the support member for the spindle system, detect the temperatures of the cross rail 34, the saddle 35, the ram 36, and the spindle bearing 40, and output the pieces of temperature data a7 to a10, respectively; and the displacement correction device 81. The displacement correction device 81 includes: the position-detector temperature-data input unit 52 which receives the temperature data a6 from the position-detector temperature sensor 41-6; the position-detector thermal-displacement-amount calculation unit 53 which calculates the amount of the thermal displacement of the position detector 42 on the basis of the temperature data a6 received by the position-detector temperature-data input unit 52; the table temperature-data input unit 54 which receives the pieces of temperature data a1 to a5 from the table temperature sensors 41-1 to 41-5; the table thermal-displacement-amount calculation unit 55 which calculates the amount of the thermal displacement of the table 32 corresponding to the temperature distribution in the X-axis direction occurring in the table 32, on the basis of the pieces of temperature data a1 to a5 received by the table temperature-data input unit 54; the table-system thermal-displacement-amount calculation unit 56 which calculates the amount of the thermal displacement of the table system with the column front surface 33a serving as the reference position X_{K}, on the basis of the amount of the thermal displacement of the position detector 42 calculated by the position-detector thermal-displacement-amount calculation unit 53 and the amount of the thermal displacement of the table calculated by the table thermal-displacement-amount calculation unit 55; the spindle-system temperature-data input unit 82 which receives the pieces of temperature data a7 to a10 from the cross-rail temperature sensor 41-7, the saddle temperature sensor 41-8, the ram temperature sensor 41-9, and the spindle-bearing temperature sensor 41-10; the spindle-system thermal-displacement-amount calculation unit 83 which calculates the amount of the thermal displacement of the spindle system with the column front surface 33a serving as the reference position X_{K}, on the basis of the pieces of temperature data a7 to a10 received by the spindle-system temperature-data input unit 82; and the X-axis-correction-amount output unit 84 which finds the X-axis correction amount on the basis of the amount of the thermal displacement of the table system calculated by the table-system thermal-displacement-amount calculation unit 56 and the amount of the thermal displacement of the spindle system calculated by the spindle-system thermal-displacement-amount calculation unit 83 and outputs the X-axis correction amount. Accordingly, it is possible to evaluate the amount of the thermal displacement of the table system (column 33→position detector 42→table 32) and of the spindle system (column 33→cross rail 34→saddle 35→ram 36→spindle bearing 40→spindle 37) with the column front surface 33a serving as the reference position X_{K}. Moreover, it is possible to perform accurate displacement correction even under the presence of a temperature distribution in the table 32 and thus variations in the amount of the thermal displacement of the table 32. Further, it is possible to design a thermal displacement model of the whole machine tool which collectively handles the amount of the thermal displacement of the table system and the amount of the thermal displacement of the spindle system. Hence, obtained is a more accurate displacement correction system.

### Embodiment 3

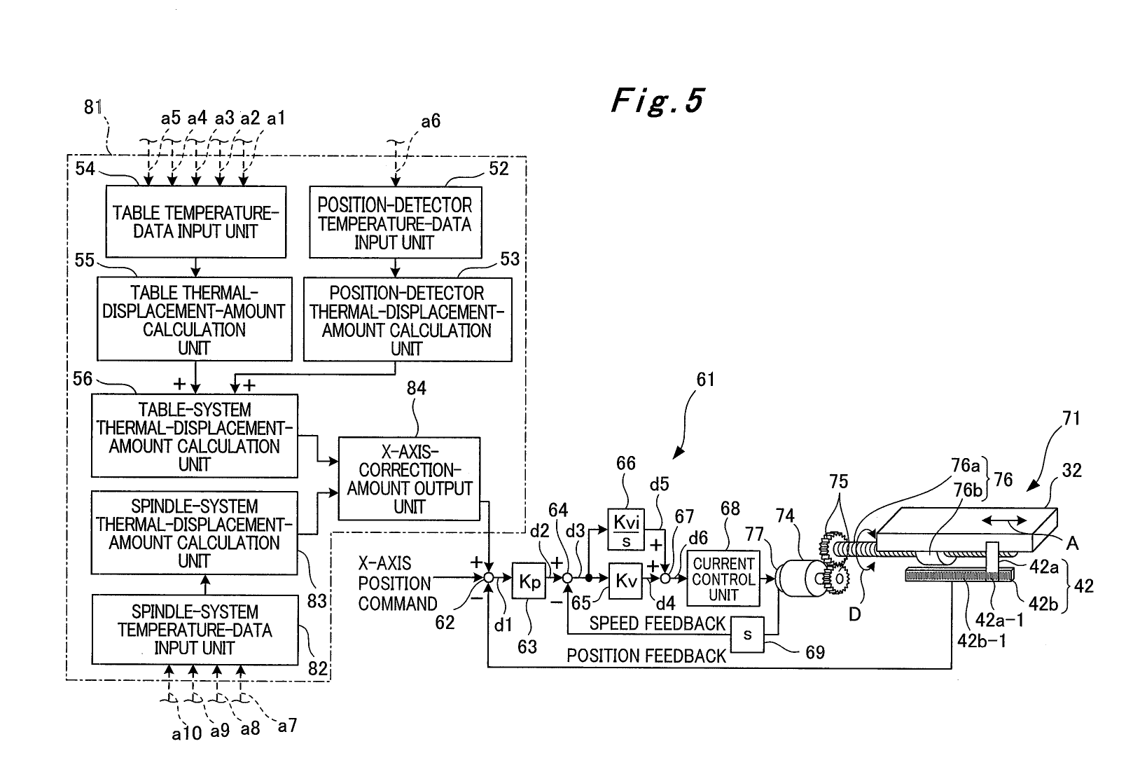

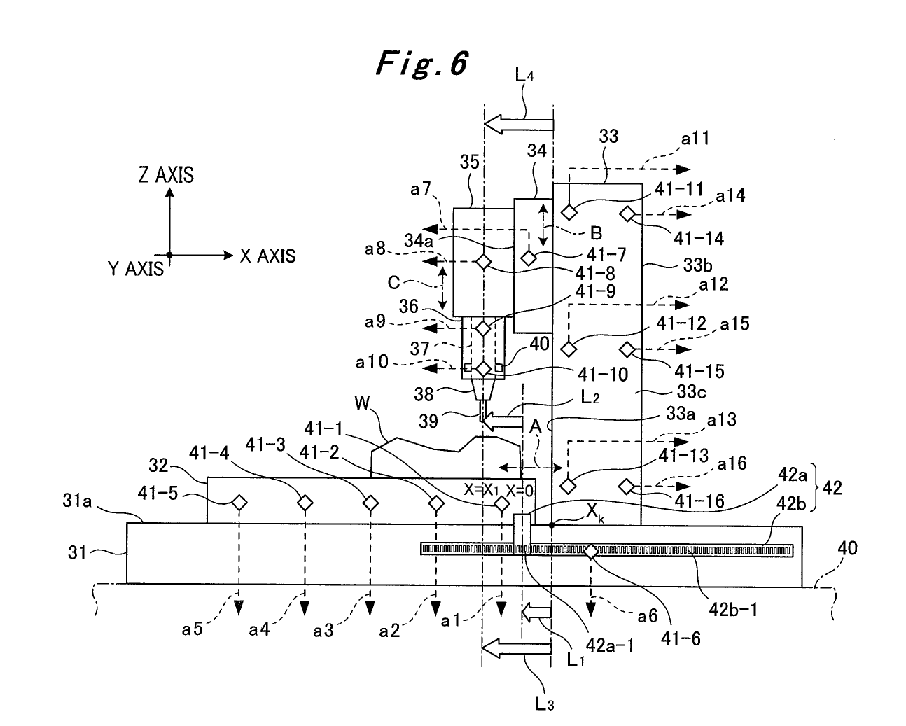

Based on FIGS. 6 to 9, a thermal displacement correction system for a machine tool according to Embodiment 3 of the present invention will be described. Note that in the thermal displacement correction system shown in FIGS. 6 and 7, the same portions as those of the thermal displacement correction systems of Embodiments 1 and 2 described above will be denoted by the same reference numerals, and overlapping descriptions thereof will be omitted.

As shown in FIG. 6, in Embodiment 3, multiple temperature sensors 41-11, 41-12, 41-13, 41-14, 41-15, and 41-16 are further disposed in the machine tool, in addition to the same temperature sensors 41-1 to 41-10 as those described above.

The column temperature sensors 41-11, 41-12, and 41-13 are disposed in upper, middle, and lower portions of the column 33 on the front surface 33a side, detect the temperatures of these upper, middle, and lower portions, and output pieces of detected temperature data all, a12, and a13 to the machine tool's displacement correction device 91 (see FIG. 7; details will be described later), respectively. The column temperature sensors 41-14, 41-15, and 41-16 are disposed in upper, middle, and lower portions of the column 33 on a rear surface 33b side, detect the temperatures of these upper, middle, and lower portions, and output pieces of detected temperature data a14, a15, and a16 to the displacement correction device 91, respectively.

As shown in FIG. 7, the displacement correction device 91 is configured by using a personal computer or the like and includes a spindle-system temperature-data input unit 92, a spindle-system thermal-displacement-amount calculation unit 93, a column temperature-data input unit 94, a column inclination-displacement-amount calculation unit 95, a spindle-system displacement-amount calculation unit 96, and an X-axis-correction-amount output unit 97, in addition to the same position-detector temperature-data input unit 52, position-detector thermal-displacement-amount calculation unit 53, table temperature-data input unit 54, table thermal-displacement-amount calculation unit 55, and table-system thermal-displacement-amount calculation unit 56 as those described above.

The spindle-system temperature-data input unit 92 receives the temperature data a7 on the cross rail 34 outputted from the cross-rail temperature sensor 41-7, the temperature data a8 on the saddle 35 outputted from the saddle temperature sensor 41-8, the temperature data a9 on the ram 36 outputted from the ram temperature sensor 41-9, the temperature data a10 on the spindle bearing 40 outputted from the spindle-bearing temperature sensor 41-10, and the pieces of temperature data a11 to a16 on the column 33 outputted from the column temperature sensors 41-11 to 41-16.

The spindle-system thermal-displacement-amount calculation unit 93 calculates the amount of thermal displacement of the spindle system in the X-axis direction on the basis of the pieces of temperature data a7 to a16 on the given parts of the spindle system received by the spindle-system temperature-data input unit 92.

Specifically, the spindle-system thermal-displacement-amount calculation unit 93 calculates the amount of thermal displacement of the cross rail 34 in the X-axis direction by substituting, into Equation (1) mentioned above, the linear expansion coefficient β of the cross rail 34, the temperature difference ΔT between the reference temperature T₀ and the temperature data T on the cross rail 34 (the temperature data a7 of the cross-rail temperature sensor 41-7), and the object effective length L of the cross rail 34. Moreover, the spindle-system thermal-displacement-amount calculation unit 93 calculates the amount of thermal displacement of the saddle 35 in the X-axis direction by substituting, into Equation (1) mentioned above, the linear expansion coefficient β of the saddle 35, the temperature difference ΔT between the reference temperature T₀ and the temperature data T on the saddle 35 (the temperature data a8 of the saddle temperature sensor 41-8), and the object effective length L of the saddle 35. Moreover, the spindle-system thermal-displacement-amount calculation unit 93 calculates the amount of thermal displacement of the ram 36 in the X-axis direction by substituting, into Equation (1) mentioned above, the linear expansion coefficient 13 of the ram 36, the temperature difference ΔT between the reference temperature T₀ and the temperature data T on the ram 36 (the temperature data a9 of the ram temperature sensor 41-9), and the object effective length L of the ram 36. Moreover, the spindle-system thermal-displacement-amount calculation unit 93 calculates the amount of thermal displacement of the spindle bearing 40 in the X-axis direction by substituting, into Equation (1) mentioned above, the linear expansion coefficient β of the spindle bearing 40, the temperature difference ΔT between the reference temperature T₀ and the temperature data T on the spindle bearing 40 (the temperature data a10 of the spindle-bearing temperature sensor 41-10), and the object effective length L of the spindle bearing 40.

Moreover, the spindle-system thermal-displacement-amount calculation unit 93 calculates the amount of thermal displacement of the column 33 in the X-axis direction by substituting, into Equation (1) mentioned above, the linear expansion coefficient β of the column 33, the temperature difference ΔT between the reference temperature T₀ and the temperature data T on the column 33, and the object effective length L of the column 33. Note that the temperature data T on the column 33 is based on the pieces of temperature data a11 to a16 from the column temperature sensors 41-11 to 41-16 and can optionally take a value such as the average value of or the greatest value among the pieces of temperature data a11 to a16.

Furthermore, the spindle-system thermal-displacement-amount calculation unit 93 uses the thermal displacement amount of the cross rail 34, the thermal displacement amount of the saddle 35, the thermal displacement amount of the ram 36, the thermal displacement amount of the spindle bearing 40, and the thermal displacement amount of the column 33 thus calculated (e.g. sums them) to calculate the thermal displacement amount of the spindle system in the X-axis direction. For example, at the position X=X₁ shown in FIG. 6, the thermal displacement amount of the spindle system is a thermal displacement amount included within a range of the length L₄ from the reference position X_{K} being the column front surface 33a to the position X=X₁ (i.e. the amount of an X-axis error resulting from the thermal displacements of the cross rail 34, saddle 35, ram 36, spindle bearing 40, and column 33).

The column temperature-data input unit 94 receives the pieces of temperature data a11 to a16 on the column 33 outputted from the column temperature sensors 41-11 to 41-16.

The column inclination-displacement-amount calculation unit 95 calculates an inclination displacement amount 6 which is the amount of displacement of the column 33 in the X-axis direction due to its inclination, on the basis of the pieces of temperature data a11 to a13 on the column front surface 33a side and the pieces of temperature data a14 to a16 on the column rear surface 33b side received by the column temperature-data input unit 94.

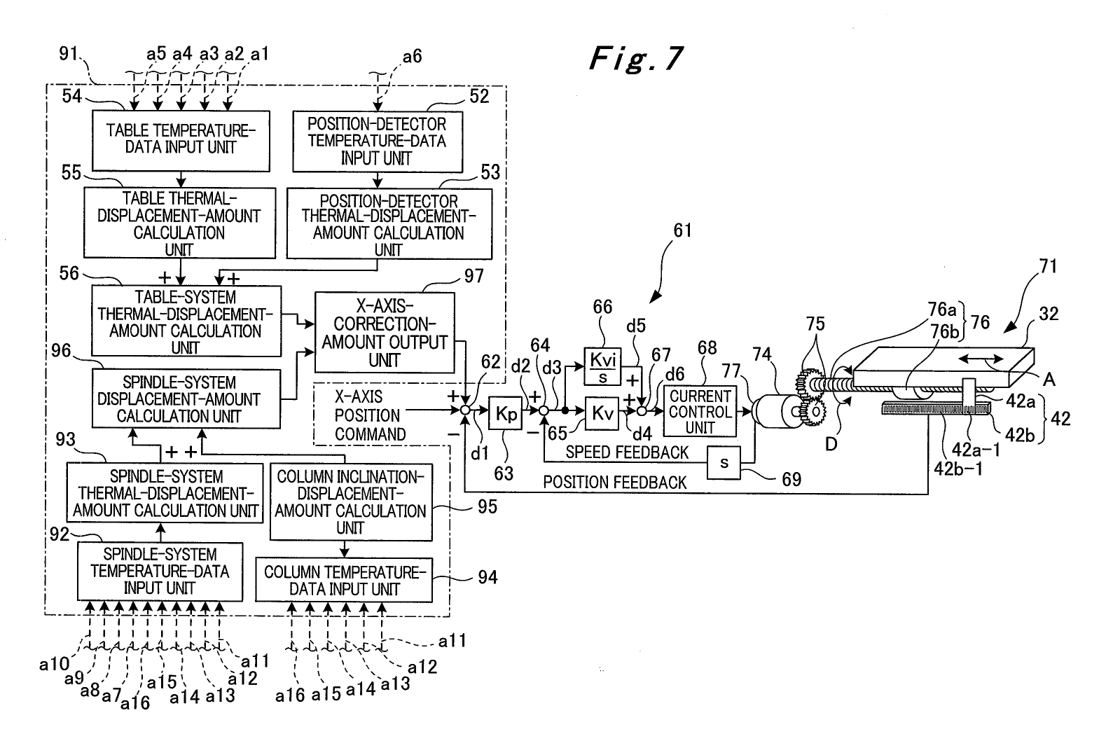

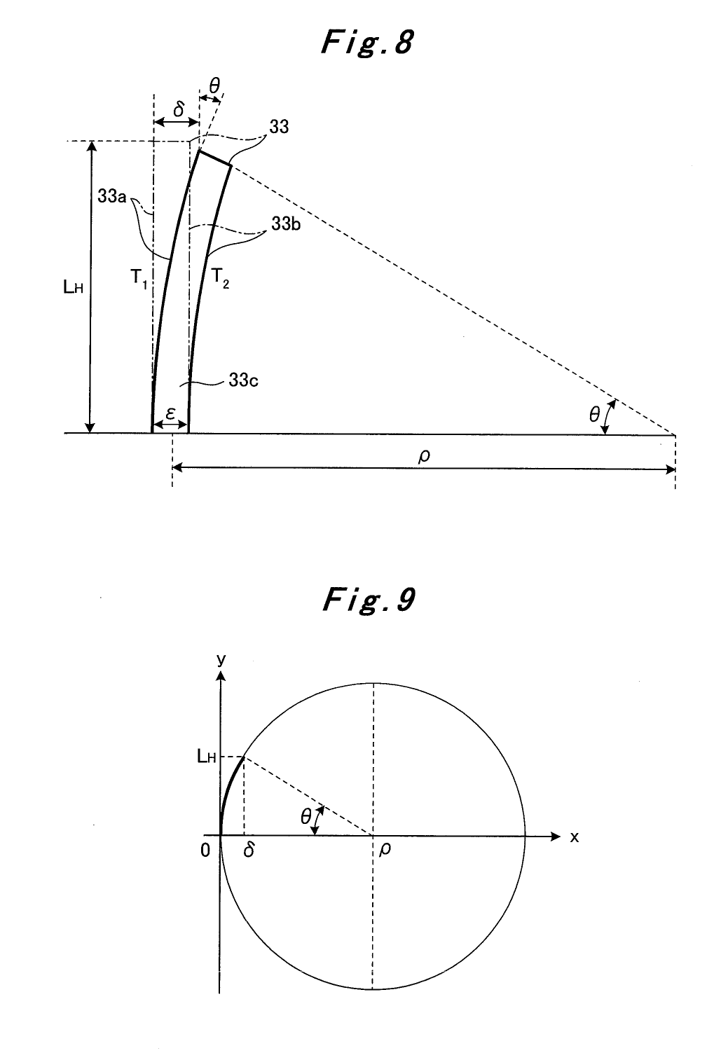

An equation for calculating the inclination displacement amount δ will be described with reference to FIGS. 8 and 9. In FIG. 8, the column 33 before the inclination is illustrated with a dashed line while the column 33 after the inclination (a state where the column 33 is deformed into an arced shape due to a temperature difference between the column front surface 33a side and the column rear surface 33b side) is illustrated with a solid line.

In FIG. 8, L_{H} is the height of the column 33; ε, the width of a column side surface 33c; T₁, the temperature data on the column front surface 33a side; T₂, the temperature data on the column rear surface 33b side; δ, the inclination displacement amount; ρ, the radius of an arc defined by the column 33 deformed into the arc shape; θ, the inclination angle of the column 33; and α, a coefficient for correcting the inclination displacement amount in the calculation of the displacement amount. Then, Equations (4) and (5) given below are obtained. From Equations (4) and (5), Equation (6) is obtained as described below, where ΔT₁ is the temperature difference between the temperature data T₁ on the column front surface 33a side and the reference temperature T₀ (T₁−T₀), and ΔT₂ is the temperature difference between the temperature data T₂ on the column rear surface 33b side and the reference temperature T₀ (T₂−T₀).

$$\begin{matrix}[ Formula 3 ] & \\ ( ρ + \frac{ɛ}{2} ) \times θ = {L}_{H} \times ( 1 + α \times Δ {T}_{1} ) & ( 4 ) \\ ( ρ - \frac{ɛ}{2} ) \times θ = {L}_{H} \times ( 1 + α \times Δ {T}_{2} ) & ( 5 ) \\ \begin{matrix}ɛ \times θ = {L}_{H} \times α \times ( Δ {T}_{1} - Δ {T}_{2} ) \\ θ = \frac{{L}_{H} \times α \times ( Δ {T}_{1} - Δ {T}_{2} )}{ɛ} \\ = \frac{{L}_{H} \times α \times ( {T}_{1} - {T}_{2} )}{ɛ}\end{matrix} & ( 6 )\end{matrix}$$

Meanwhile, Equation (7) given below is obtained by respectively assigning the inclination displacement amount 6 and the height L_{H} of the column 33 (see FIG. 8) to x and y in an equation (x−ρ)²+y²=ρ² of a circle as shown in FIG. 9. From Equation (7), Equation (8) is obtained as described below. Moreover, Equation (9) given below is obtained by substituting Equation (6) into 0 in Equation (8). From Equation (9), Equation (10) is obtained as described below. Then, by substituting the temperature data T₁ and T₂ into Equation (10), the inclination displacement amount 6 can be calculated. Note that the temperature data T₁ can take the value of any of the pieces of the temperature data a11 to a13 on the column front surface 33a side or the average value thereof. The temperature data T₂ can take the value of any of the pieces of the temperature data a14 to a16 on the column rear surface 33b side or the average value thereof.

$$\begin{matrix}[ Formula 4 ] & \\ {( δ - ρ )}^{2} + {L}_{H}^{2} = {ρ}^{2} & ( 7 ) \\ \begin{matrix}δ = ρ - \sqrt{{ρ}^{2} - {L}_{H}^{2}} \\ = \frac{{ρ}^{2} - ( {ρ}^{2} - {L}_{H}^{2} )}{ρ + \sqrt{{ρ}^{2} - {L}_{H}^{2}}} \\ \approx \frac{{L}_{H}^{2}}{2 \times ρ} \\ = \frac{{L}_{H}^{2}}{2 \times {L}_{H} / θ} \\ = \frac{{L}_{H} \times θ}{2} ( 9 ) \\ = \frac{{L}_{H}}{2} \times [ \frac{{L}_{H} \times α \times ( Δ {T}_{1} - Δ {T}_{2} )}{ɛ} ] \\ = \frac{{L}_{H}^{2} \times α \times ( Δ {T}_{1} - Δ {T}_{2} )}{2 \times ɛ} \\ = \frac{{L}_{H}^{2} \times α \times ( {T}_{1} - {T}_{2} )}{2 \times ɛ} ( 10 )\end{matrix} & ( 8 )\end{matrix}$$

As shown in FIG. 7, the spindle-system displacement-amount calculation unit 96 uses the thermal displacement amount of the spindle system calculated by the spindle-system thermal-displacement-amount calculation unit 93 and the inclination displacement amount 5 calculated by the column inclination-displacement-amount calculation unit 95 (e.g. sums them) to calculate the amount of X-axis displacement in the spindle system, and then outputs this amount to the X-axis-correction-amount output unit 97.

The X-axis-correction-amount output unit 97 uses the X-axis displacement amount of the table system (the thermal displacement amount of the table system) inputted from the table-system thermal-displacement-amount calculation unit 56 and the X-axis displacement amount of the spindle system (the thermal displacement amount and inclination displacement amount of the spindle system) inputted from the spindle-system displacement-amount calculation unit 96 (e.g. subtracts one from the other) to find an X-axis correction amount for the table system and the spindle system (=“−X-axis displacement amount”) and outputs this X-axis correction amount (=“−X-axis displacement amount”) to the feedback control device 61.

The deviation computation unit 62 of the feedback control device 61 adds the X-axis correction amount (=“−X-axis displacement amount”) sent from the displacement correction device 91 (X-axis-correction-amount output unit 97) to an X-axis position command sent from the numerical control device (not shown) to correct the X-axis position command. The deviation computation unit 62 computes the difference between this corrected X-axis position command and the position of the table 32 (workpiece W) which is the position feedback information from the position detector 42 to find the position deviation d1.

The other parts of the configuration of the thermal displacement correction system of Embodiment 3 are the same as those of the thermal displacement correction systems of Embodiments 1 and 2 described above.

As described above, the thermal displacement correction system for a machine tool in Embodiment 3 is a thermal displacement correction system for a machine tool including: the spindle 37 with the tool 39 mounted thereto; the column 33; the cross rail 34, the saddle 35, the ram 36, and the spindle bearing 40 provided between the spindle 37 and the column 33 as the support member for the spindle system; the table 32 movable in the X-axis direction which is the front-rear direction of the column 33; and the position detector 42 which detects the position of the table 32 in the X-axis direction. This thermal displacement correction system is characterized in that it includes: the position-detector temperature sensor 41-6 which is disposed in the position detector 42, detects the temperature of the position detector 42, and outputs the temperature data a6; the multiple table temperature sensors 41-1 to 41-5 which are disposed in the given portions of the table 32 along the X-axis direction, detect the temperatures of the given portions of the table 32, and output the pieces of temperature data a1 to a5, respectively; the cross-rail temperature sensor 41-7, the saddle temperature sensor 41-8, the ram temperature sensor 41-9, and the spindle-bearing temperature sensor 41-10 as the support-member temperature sensors which are disposed in the cross-rail 34, the saddle 35, the ram 36, and the spindle bearing 40 as the support member for the spindle system, detect the temperatures of the cross rail 34, the saddle 35, the ram 36, and the spindle bearing 40, and output the pieces of temperature data a7 to a10, respectively; the column temperature sensors 41-11 to 41-16 which are disposed in the front surface 33a side and the rear surface 33b side of the column 33, detect the temperatures of the front surface 33a side and the rear surface 33b side of the column 33, and respectively output the pieces of temperature data a11 to a16; and the displacement correction device 91. The displacement correction device 91 includes: the position-detector temperature-data input unit 52 which receives the temperature data a6 from the position-detector temperature sensor 41-6; the position-detector thermal-displacement-amount calculation unit 53 which calculates the amount of the thermal displacement of the position detector 42 on the basis of the temperature data a6 received by the position-detector temperature-data input unit 52; the table temperature-data input unit 54 which receives the pieces of temperature data a1 to a5 from the table temperature sensors 41-1 to 41-5; the table thermal-displacement-amount calculation unit 55 which calculates the amount of the thermal displacement of the table 32 corresponding to the temperature distribution in the X-axis direction occurring in the table 32, on the basis of the pieces of temperature data a1 to a5 received by the table temperature-data input unit 54; the table-system thermal-displacement-amount calculation unit 56 which calculates the amount of the thermal displacement of the table system with the column front surface 33a serving as the reference position X_{K}, on the basis of the amount of the thermal displacement of the position detector 42 calculated by the position-detector thermal-displacement-amount calculation unit 53 and the amount of the thermal displacement of the table calculated by the table thermal-displacement-amount calculation unit 55; the spindle-system temperature-data input unit 92 which receives the pieces of temperature data a7 to a16 from the cross-rail temperature sensor 41-7, the saddle temperature sensor 41-8, the ram temperature sensor 41-9, the spindle-bearing temperature sensor 41-10, and the column temperature sensors 41-11 to 41-16; the spindle-system thermal-displacement-amount calculation unit 93 which calculates the amount of the thermal displacement of the spindle system with the column front surface 33a serving as the reference position X_{K}, on the basis of the pieces of temperature data a7 to a16 received by the spindle-system temperature-data input unit 92; the column temperature-data input unit 94 which receives the pieces of temperature data a11 to a16 from the column temperature sensors 41-11 to 41-16; the column inclination-displacement-amount calculation unit 95 which calculates the amount of the inclination displacement of the column 33 on the basis of the pieces of temperature data a11 to a16 received by the column temperature-data input unit 94; the spindle-system displacement-amount calculation unit 96 which calculates the amount of the displacement of the spindle system on the basis of the amount of the thermal displacement of the spindle system calculated by the spindle-system thermal-displacement-amount calculation unit 93 and the amount of the inclination displacement of the column 33 calculated by the column inclination-displacement-amount calculation unit 95; and the X-axis-correction-amount output unit 97 which finds the X-axis correction amount on the basis of the amount of the thermal displacement of the table system calculated by the table-system thermal-displacement-amount calculation unit 56 and the amount of the displacement of the spindle system calculated by the spindle-system displacement-amount calculation unit 96 and outputs the X-axis correction amount. Accordingly, it is possible to evaluate the amount of the thermal displacement of the table system (column 33→position detector 42→table 32) and of the spindle system (column 33→cross rail 34→saddle 35→ram 36→spindle bearing 40→spindle 37) with the column front surface 33a serving as the reference position X_{K}. Moreover, it is possible to perform accurate displacement correction even under the presence of a temperature distribution in the table 32 and thus variations in the amount of the thermal displacement of the table 32. Further, it is possible to design a thermal displacement model of the whole machine tool which collectively handles the amount of the thermal displacement of the table system and the amount of the thermal displacement of the spindle system. Hence, obtained is a more accurate displacement correction system. Furthermore, it is possible to perform even more accurate displacement correction because the amount of the inclination displacement of the column 33 is taken into consideration in addition to the amounts of the thermal displacements of the table system and spindle system.

### Embodiment 4

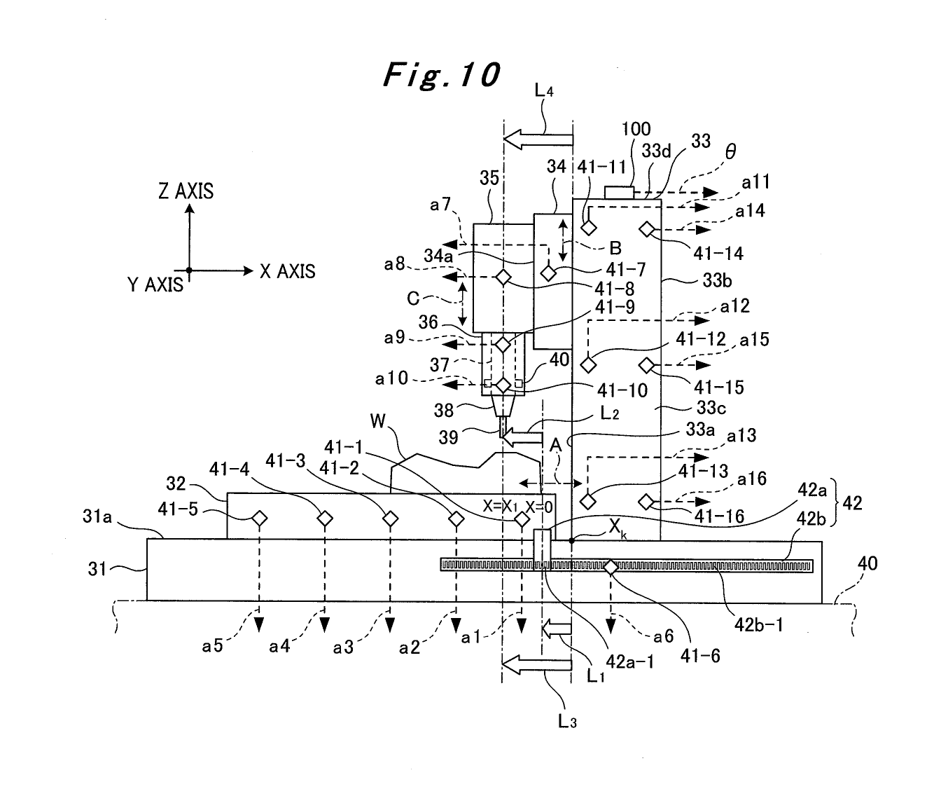

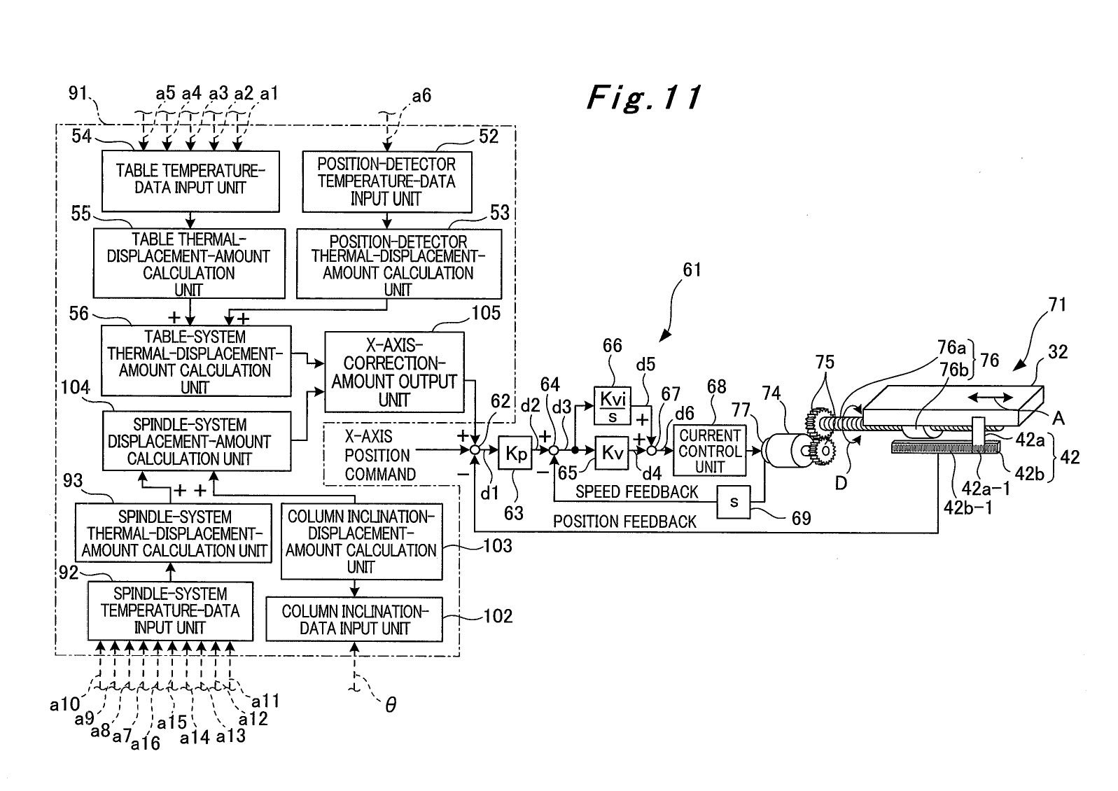

Based on FIGS. 10 and 11, a thermal displacement correction system for a machine tool according to Embodiment 4 of the present invention will be described. Note that in the thermal displacement correction system shown in FIGS. 10 and 11, the same portions as those of the thermal displacement correction systems of Embodiments 1 to 3 described above will be denoted by the same reference numerals, and overlapping descriptions thereof will be omitted.

As shown in FIG. 10, in Embodiment 4, a level 100 is disposed in the machine tool, in addition to the same temperature sensors 41-1 to 41-16 as those described above. The level 100 is disposed on an upper surface 33d of the column 33, detects the inclination angle θ of the column 33, and outputs detected inclination data θ to the machine tool's displacement correction device 101 (see FIG. 11; details will be described later).

As shown in FIG. 11, the displacement correction device 101 is configured by using a personal computer or the like and includes a column inclination-data input unit 102, a column inclination-displacement-amount calculation unit 103, a spindle-system displacement-amount calculation unit 104, and an X-axis-correction-amount output unit 105, in addition to the same position-detector temperature-data input unit 52, position-detector thermal-displacement-amount calculation unit 53, table temperature-data input unit 54, table thermal-displacement-amount calculation unit 55, table-system thermal-displacement-amount calculation unit 56, spindle-system temperature-data input unit 92, and spindle-system thermal-displacement-amount calculation unit 93 as those described above.

The column inclination-data input unit 102 receives the inclination data 9 on the column 33 outputted from the level 100.

The column inclination-displacement-amount calculation unit 103 calculates the inclination displacement amount 5, which is the amount of the displacement of the column 33 in the X-axis direction due to its inclination, on the basis of the inclination data θ on the column 33 received by the column inclination-data input unit 102. For example, this inclination displacement amount δ can be calculated by substituting the inclination data θ into Equation (8) mentioned above.

The spindle-system displacement-amount calculation unit 104 uses the thermal displacement amount of the spindle system calculated by the spindle-system thermal-displacement-amount calculation unit 93 and the inclination displacement amount 6 calculated by the column inclination-displacement-amount calculation unit 103 (e.g. sums them) to calculate the amount of X-axis displacement of the spindle system, and then outputs this amount to the X-axis-correction-amount output unit 105.

The X-axis-correction-amount output unit 105 uses the X-axis displacement amount of the table system (the thermal displacement amount of the table system) inputted from the table-system thermal-displacement-amount calculation unit 56 and the X-axis displacement amount in the spindle system (the thermal displacement amount and inclination displacement amount of the spindle system) inputted from the spindle-system displacement-amount calculation unit 104 (e.g. subtracts one from the other) to find an X-axis correction amount for the table system and the spindle system (=“−X-axis displacement amount”) and outputs this X-axis correction amount (=“−X-axis displacement amount”) to the feedback control device 61.

The deviation computation unit 62 of the feedback control device 61 adds the X-axis correction amount (=“−X-axis displacement amount”) sent from the displacement correction device 101 (X-axis-correction-amount output unit 105) to an X-axis position command sent from the numerical control device (not shown) to correct the X-axis position command. The deviation computation unit 62 computes the difference between this corrected X-axis position command and the position of the table 32 (workpiece W) which is the position feedback information from the position detector 42 to find the position deviation d1.

The other parts of the configuration of the thermal displacement correction system of Embodiment 4 are the same as those of the thermal displacement correction systems of Embodiments 1 to 3 described above.

As described above, the thermal displacement correction system for a machine tool in Embodiment 4 is a thermal displacement correction system for a machine tool including: the spindle 37 with the tool 39 mounted thereto; the column 33; the cross rail 34, the saddle 35, the ram 36, and the spindle bearing 40 provided between the spindle 37 and the column 33 as the support member for the spindle system; the table 32 movable in the X-axis direction which is the front-rear direction of the column 33; and the position detector 42 which detects the position of the table 32 in the X-axis direction. This thermal displacement correction system is characterized in that it includes: the position-detector temperature sensor 41-6 which is disposed in the position detector 42, detects the temperature of the position detector 42, and outputs the temperature data a6; the multiple table temperature sensors 41-1 to 41-5 which are disposed in the given portions of the table 32 along the X-axis direction, detect the temperatures of the given portions of the table 32, and output the pieces of temperature data a1 to a5, respectively; the cross-rail temperature sensor 41-7, the saddle temperature sensor 41-8, the ram temperature sensor 41-9, and the spindle-bearing temperature sensor 41-10 as the support-member temperature sensors which are disposed in the cross-rail 34, the saddle 35, the ram 36, and the spindle bearing 40 as the support member for the spindle system, detect the temperatures of the cross rail 34, the saddle 35, the ram 36, and the spindle bearing 40, and output the pieces of temperature data a7 to a10, respectively; the column temperature sensors 41-11 to 41-16 which are disposed in the column 33, detect the temperatures of the column 33, and respectively output the pieces of temperature data a11 to a16; the level 100 which is disposed on the column 33, detects the inclination angle of the column 33, and outputs the inclination data B; and the displacement correction device 101. The displacement correction device 101 includes: the position-detector temperature-data input unit 52 which receives the temperature data a6 from the position-detector temperature sensor 41-6; the position-detector thermal-displacement-amount calculation unit 53 which calculates the amount of the thermal displacement of the position detector 42 on the basis of the temperature data a6 received by the position-detector temperature-data input unit 52; the table temperature-data input unit 54 which receives the pieces of temperature data a1 to a5 from the table temperature sensors 41-1 to 41-5; the table thermal-displacement-amount calculation unit 55 which calculates the amount of the thermal displacement of the table 32 corresponding to the temperature distribution in the X-axis direction occurring in the table 32, on the basis of the pieces of temperature data a1 to a5 received by the table temperature-data input unit 54; the table-system thermal-displacement-amount calculation unit 56 which calculates the amount of the thermal displacement of the table system with the column front surface 33a serving as the reference position X_{K}, on the basis of the amount of the thermal displacement of the position detector 42 calculated by the position-detector thermal-displacement-amount calculation unit 53 and the amount of the thermal displacement of the table calculated by the table thermal-displacement-amount calculation unit 55; the spindle-system temperature-data input unit 92 which receives the pieces of temperature data a7 to a16 from the cross-rail temperature sensor 41-7, the saddle temperature sensor 41-8, the ram temperature sensor 41-9, the spindle-bearing temperature sensor 41-10, and the column temperature sensors 41-11 to 41-16; the spindle-system thermal-displacement-amount calculation unit 93 which calculates the amount of the thermal displacement of the spindle system with the column front surface 33a serving as the reference position X_{K}, on the basis of the pieces of temperature data a7 to a16 received by the spindle-system temperature-data input unit 92; the column inclination-data input unit 102 which receives the inclination data θ from the level 100; the column inclination-displacement-amount calculation unit 103 which calculates the amount of the inclination displacement of the column 33 on the basis of the inclination data θ received by the column inclination-data input unit 102; the spindle-system displacement-amount calculation unit 104 which calculates the amount of the displacement of the spindle system on the basis of the amount of the thermal displacement of the spindle system calculated by the spindle-system thermal-displacement-amount calculation unit 93 and the amount of the inclination displacement of the column 33 calculated by the column inclination-displacement-amount calculation unit 103; and the X-axis-correction-amount output unit 105 which finds the X-axis correction amount on the basis of the amount of the thermal displacement of the table system calculated by the table-system thermal-displacement-amount calculation unit 56 and the amount of the displacement of the spindle system calculated by the spindle-system displacement-amount calculation unit 104 and outputs the X-axis correction amount. Accordingly, it is possible to evaluate the amount of the thermal displacement of the table system (column 33→position detector 42→table 32) and of the spindle system (column 33→cross rail 34→saddle 35→ram 36→spindle bearing 40→spindle 37) with the column front surface 33a serving as the reference position X_{K}. Moreover, it is possible to perform accurate displacement correction even under the presence of a temperature distribution in the table 32 and thus variations in the amount of the thermal displacement of the table 32. Further, it is possible to design a thermal displacement model of the whole machine tool which collectively handles the amount of the thermal displacement of the table system and the amount of the thermal displacement of the spindle system. Hence, obtained is a more accurate displacement correction system. Furthermore, it is possible to perform even more accurate displacement correction because the amount of the inclination displacement of the column is taken into consideration in addition to the amounts of the thermal displacements of the table system and spindle system.

### INDUSTRIAL APPLICABILITY

The present invention relates to a thermal displacement correction system for a machine tool and is useful for application to thermal displacement correction systems for various machine tools such as a double-column-type machining center and a vertical machining center.

### EXPLANATION OF THE REFERENCE NUMERALS

31 bed
31a upper surface
32 table
33 column
33a column front surface
33b column rear surface
33c column side surface
33d column upper surface
34 cross rail
34a cross-rail front surface
35 saddle
36 ram
37 spindle
38 attachment
39 tool
40 spindle bearing
41-1 to 41-5 table temperature sensor
41-6 position-detector temperature sensor
41-7 cross-rail temperature sensor
41-8 saddle temperature sensor
41-9 ram temperature sensor
41-10 spindle-bearing temperature sensor
41-11 to 41-16 column temperature sensor
42 position detector
42a slider
42a-1 coil
42b scale
42b-1 coil
51 displacement correction device
52 position-detector temperature-data input unit
53 position-detector thermal-displacement-amount calculation unit
54 table temperature-data input unit
55 table thermal-displacement-amount calculation unit
56 table-system thermal-displacement-amount calculation unit
57 X-axis-correction-amount output unit
61 feedback control device
62 deviation computation unit
63 multiplication unit
64 deviation computation unit
65 proportional computation unit
66 integral computation unit
67 adding unit
68 current control unit
69 derivative computation unit
71 table feed mechanism
74 servomotor
75 reduction gear
76 ball screw
76a screw part
76b nut part
77 pulse coder
81 displacement correction device
82 spindle-system temperature-data input unit
83 spindle-system thermal-displacement-amount calculation unit
84 X-axis-correction-amount output unit
91 displacement correction device
91 spindle-system temperature-data input unit
93 spindle-system thermal-displacement-amount calculation unit
94 column temperature-data input unit
95 column inclination-displacement-amount calculation unit
96 spindle-system displacement-amount calculation unit
97 X-axis-correction-amount output unit
101 displacement correction device
102 column inclination-data input unit
103 column inclination-displacement-amount calculation unit
104 spindle-system displacement-amount calculation unit
105 X-axis-correction-amount output unit

1. A thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:
a position-detector temperature sensor which is disposed in the position detector, detects a temperature of the position detector, and outputs temperature data;
a plurality of table temperature sensors which are disposed in given portions of the table along the X-axis direction, detect temperatures of the given portions of the table, and output pieces of temperature data, respectively; and
a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit, and
an X-axis-correction-amount output unit which finds an X-axis correction amount on the basis of the amount of the thermal displacement of the table system calculated by the table-system thermal-displacement-amount calculation unit and outputs the X-axis correction amount.

2. A thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:
a position-detector temperature sensor which is disposed in the position detector, detects a temperature of the position detector, and outputs temperature data;
a plurality of table temperature sensors which are disposed in given portions of the table along the X-axis direction, detect temperatures of the given portions of the table, and output pieces of temperature data, respectively;
a support-member temperature sensor which is disposed in the support member for the spindle system, detects a temperature of the support member for the spindle system, and outputs temperature data; and
a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit, and
an X-axis-correction-amount output unit which finds an X-axis correction amount on the basis of the amount of the thermal displacement of the table system calculated by the table-system thermal-displacement-amount calculation unit and the amount of the thermal displacement of the spindle system calculated by the spindle-system thermal-displacement-amount calculation unit and outputs the X-axis correction amount.

3. A thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:
a position-detector temperature sensor which is disposed in the position detector, detects a temperature of the position detector, and outputs temperature data;
a plurality of table temperature sensors which are disposed in given portions of the table along the X-axis direction, detect temperatures of the given portions of the table, and output pieces of temperature data, respectively;
a support-member temperature sensor which is disposed in the support member for the spindle system, detects a temperature of the support member for the spindle system, and outputs temperature data;
column temperature sensors which are disposed in a front surface side and a rear surface side of the column, detect temperatures of the front surface side and the rear surface side of the column, and respectively output pieces of temperature data; and
a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit,
a column temperature-data input unit which receives the pieces of temperature data from the column temperature sensors,
a column inclination-displacement-amount calculation unit which calculates an amount of inclination displacement of the column on the basis of the pieces of temperature data received by the column temperature-data input unit,
a spindle-system displacement-amount calculation unit which calculates an amount of displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit, and
an X-axis-correction-amount output unit which finds an X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount.

4. The thermal displacement correction system for a machine tool according to claim 3, characterized in that
the spindle-system temperature-data input unit receives the pieces of temperature data from the support-member temperature sensor and the column temperature sensors, and
the spindle-system thermal-displacement-amount calculation unit calculates the amount of the thermal displacement of the spindle system with the front surface of the column serving as the reference position, on the basis of the pieces of temperature data from the support-member temperature sensor and the column temperature sensors received by the spindle-system temperature-data input unit.

5. A thermal displacement correction system for a machine tool including: a spindle with a tool mounted thereto; a column; a support member for a spindle system, the support member provided between the spindle and the column; a table movable in an X-axis direction which is a front-rear direction of the column; and a position detector which detects a position of the table in the X-axis direction, the thermal displacement correction system characterized in that the thermal displacement correction system comprises:
a position-detector temperature sensor which is disposed in the position detector, detects a temperature of the position detector, and outputs temperature data;
a plurality of table temperature sensors which are disposed in given portions of the table along the X-axis direction, detect temperatures of the given portions of the table, and output pieces of temperature data, respectively;
a support-member temperature sensor which is disposed in the support member for the spindle system, detects a temperature of the support member for the spindle system, and outputs temperature data;
a level which is disposed on the column, detects an inclination angle of the column, and outputs inclination data; and
a displacement correction device including
a position-detector temperature-data input unit which receives the temperature data from the position-detector temperature sensor,
a position-detector thermal-displacement-amount calculation unit which calculates an amount of thermal displacement of the position detector on the basis of the temperature data received by the position-detector temperature-data input unit,
a table temperature-data input unit which receives the pieces of temperature data from the table temperature sensors,
a table thermal-displacement-amount calculation unit which calculates an amount of thermal displacement of the table corresponding to a temperature distribution in the X-axis direction occurring in the table, on the basis of the pieces of temperature data received by the table temperature-data input unit,
a table-system thermal-displacement-amount calculation unit which calculates an amount of thermal displacement of a table system with a front surface of the column serving as a reference position, on the basis of the amount of the thermal displacement of the position detector calculated by the position-detector thermal-displacement-amount calculation unit and the amount of the thermal displacement of the table calculated by the table thermal-displacement-amount calculation unit,
a spindle-system temperature-data input unit which receives the temperature data from the support-member temperature sensor,
a spindle-system thermal-displacement-amount calculation unit which calculates an amount of thermal displacement of the spindle system with the front surface of the column serving as the reference position, on the basis of the temperature data received by the spindle-system temperature-data input unit,
a column inclination-data input unit which receives the inclination data from the level,
a column inclination-displacement-amount calculation unit which calculates an amount of inclination displacement of the column on the basis of the inclination data received by the column inclination-data input unit,
a spindle-system displacement-amount calculation unit which calculates an amount of displacement of the spindle system on the basis of the amount of the thermal displacement of the spindle system calculated by the spindle-system thermal-displacement-amount calculation unit and the amount of the inclination displacement of the column calculated by the column inclination-displacement-amount calculation unit, and
an X-axis-correction-amount output unit which finds an X-axis correction amount on the basis of the amount of the thermal displacement of the table system calculated by the table-system thermal-displacement-amount calculation unit and the amount of the displacement of the spindle system calculated by the spindle-system displacement-amount calculation unit and outputs the X-axis correction amount.

6. The thermal displacement correction system for a machine tool according to claim 5, characterized in that the thermal displacement correction system further comprises a column temperature sensor which is disposed in the column, detects a temperature of the column, and outputs temperature data, wherein
the spindle-system temperature-data input unit receives the pieces of temperature data from the support-member temperature sensor and the column temperature sensor, and
the spindle-system thermal-displacement-amount calculation unit calculates the amount of the thermal displacement of the spindle system with the front surface of the column serving as the reference position, on the basis of the pieces of temperature data from the support-member temperature sensor and the column temperature sensor received by the spindle-system temperature-data input unit.
